(19) United States
(12) Patent Application Publication
(10) Pub. No.: US 2024/0370050 A1
(43) Pub. Date: Nov. 7, 2024

(54) SYSTEMS AND METHODS FOR COHERENT PHOTONIC CROSSBAR ARRAYS

(71) Applicant: University of Pittsburgh - Of the Commonwealth System of Higher Education, Pittsburgh, PA (US)

(72) Inventor: Nathan YOUNGBLOOD, Pittsburgh, PA (US)

(73) Assignee: University of Pittsburgh - Of the Commonwealth System of Higher Education, Pittsburgh, PA (US)

(21) Appl. No.: 18/691,031

(22) PCT Filed: Sep. 13, 2022
(86) PCT No.: PCT/US2022/043289

§ 371 Date: Mar. 11, 2024

Related U.S. Application Data
(60) Provisional application No. 63/244,171, filed on Sep. 14, 2021.
(60) Provisional application No. 63/278,885, filed on Nov. 12, 2021.

(51) Int. Cl. G06E 3/00; G06N 3/049; G06N 3/067

(52) U.S. Cl. CPC G06E 3/008; G06N 3/049; G06N 3/067

(57) ABSTRACT

A device for performing vector operations is provided. The device includes a photonic crossbar array. The photonic crossbar array includes a plurality of unit cells. One or more of the plurality of unit cells includes a beam splitter, a first photodetector, and a second photodetector. The one or more unit cells are configured to output, as a unit cell output, a third output of the optical signal and a fourth output of the optical signal. The device includes a controller configured to encode a first vector in time-varying amplitudes or time-varying phases of a first electric field, encode a second vector in time-varying amplitudes or time-varying phases of a second electric field, and determine a result of multiplication of the first vector and the second vector based on the unit cell output from the one or more of the plurality of unit cells.

### CROSS-REFERENCE TO RELATED PATENT APPLICATIONS

This application claims priority to U.S. Provisional Application No. 63/244,171, filed Sep. 14, 2021, and U.S. Provisional Application No. 63/278,885, filed Nov. 12, 2021, which are incorporated herein by reference in their entireties.

### BACKGROUND

Deep learning research is computationally intensive. Advances in deep learning research are associated with increased demand for computing power.

### SUMMARY

Deep learning research itself, and especially advancements in deep learning research, impose increasingly unsustainable demands for computing power. The need for higher computing power has dramatically outpaced the comparatively slower growth in the performance and efficiency of electronic computing hardware.

The systems and methods of the present disclosure are directed to a hybrid photonic-electronic computing architecture which can leverage a photonic crossbar array and homodyne detection to perform large-scale coherent matrix-matrix multiplication. Two major factors limiting efficiency for many analog computing approaches include energy consumption and latency with respect to the limit for large matrices. The present disclosure allows for implementations which avoid the need for high-speed electronic readout and frequent reprogramming of photonic weights, significantly reducing energy consumption and latency in the limit for large matrices.

At least one aspect of the present disclosure is directed to a device for performing vector operations. The device can include a photonic crossbar array. The photonic crossbar array can include a plurality of unit cells. One or more of the plurality of unit cells can include a beam splitter. The beam splitter can be configured to receive a first input of an optical signal and a second input of the optical signal. The first input and the second input can be temporally and spatially coherent. The beam splitter can also output a first output of the optical signal and a second output of the optical signal. The one or more of the plurality of unit cells can also include (i) a first photodetector configured to receive the first output of the optical signal and generate a third output of the optical signal; and (ii) a second photodetector configured to receive the second output of the optical signal, and generate a fourth output of the optical signal. Further, the one or more unit cells can be configured to output, as a unit cell output, the third output of the optical signal and the fourth output of the optical signal. The device can include a controller. The controller can encode a first vector in at least one of time-varying amplitudes of a first electric field or time-varying phases of the first electric field. The controller can also encode a second vector in at least one of time-varying amplitudes of a second electric field or time-varying phases of the second electric field. Finally, the controller can be configured to perform the at least one vector operation by multiplying the first vector and the second vector based on the unit cell output from the one or more of the plurality of unit cells, followed by determining a result of the multiplication.

In at least one aspect, the device described herein further comprises (a) a plurality of the beam splitters; (b) a light emitter configured to transmit the optical signal; and (c) a plurality of modulators coupled with the photonic crossbar array. In addition, one or more of the plurality of modulators can be configured to: (i) receive the optical signal from the light emitter; (ii) modulate amplitudes of the optical signal; (iii) modulate phases of the optical signal; and (iv) transmit the modulated amplitudes of the optical signal and modulated phases of the optical signal to one or more of the plurality of beam splitters.

In at least one aspect, the device described herein can further comprise an intensity modulator configured to: (a) receive optical signals from a light source; (b) modulate the amplitudes of the optical signal; and (c) transmit modulated amplitudes of the optical signal to a plurality of modulators. In one aspect, the intensity modulator is at least one of a balanced Mach-Zehnder Interferometer (MZI) or a ring resonator.

In at least one aspect of the device described herein, the beam splitter is at least one of a 3 dB directional coupler, a 50:50 beam splitter, or a multimode interferometer. In another aspect, the device described herein can further comprise a fixed-weight photonic component.

In at least one aspect, the device described herein comprises the beam splitter, the first photodetector, and the second photodetector disposed on a substrate. In yet a further aspect, (i) the beam splitter is disposed on a substrate, and (ii) the first photodetector and the second photodetector are disposed in free space.

In at least one aspect of the device described herein, the optical signal encodes at least one matrix element. The at least one matrix element can be at least one of a tensor, a matrix, or a vector.

Yet another aspect of the present disclosure is directed to a method of performing vector operations. The method can include encoding, by a controller, a first vector in at least one of time-varying amplitudes of a first electric field or time-varying phases of the first electric field. The method can further include encoding, by the controller, a second vector in at least one of time-varying amplitudes of a second electric field or time-varying phases of the second electric field. The method can also include transmitting, by the controller, a first input of an optical signal and a second input of the optical signal to a beam splitter to generate a first output of the optical signal and a second output of the optical signal. The first input and the second input can be temporally and spatially coherent.

In at least one aspect, the method can also include transmitting, by the controller, the first output of the optical signal a first photodetector to generate a third output of the optical signal. The method can further include transmitting, by the controller, the second output of the optical signal to a second photodetector to generate a fourth output of the optical signal. A unit cell output can include the third output of the optical signal and the fourth output of the optical signal. The method can further include performing the at least one vector operation by multiplying the first vector and the second vector based on the unit cell output from one or more of a plurality of unit cells. Finally, the method can include determining, by the controller, a result of multiplication of the first vector and the second vector based on the unit cell output from one or more of a plurality of unit cells.

In at least one aspect, the method further includes determining, by the controller, a difference between the third output of the optical signal and the fourth output of the optical signal. In addition, the method can also further comprise time-multiplexing, by the controller, the first vector and the second vector.

In at least one aspect, in the method as described herein, the optical signal encodes matrix elements of at least one of a tensor, a matrix, or a vector. In addition, the method can further comprise scaling, by the controller, the matrix elements of at the least one of the matrix or the vector to a value in a range of [−1, 1].

In at least one aspect, the method described herein further includes performing, by the controller, real or complex matrix multiplication by controlling phases of the optical signal and amplitudes of the optical signal.

In at least one aspect, the method described herein further comprises measuring, by the controller, optical intensity on a substrate.

In at least one aspect, the method described herein further comprises transmitting, by a light source, the optical signal.

In at least a further aspect, the method described herein further comprises (a) receiving, by one or more of a plurality of modulators, the optical signal from a light source; (b) modulating, by the one or more of the modulators, amplitudes of the optical signal; (c) modulating, by the one or more of the modulators, phases of the optical signal; and (d) transmitting, by the one or more of the modulators, the modulated amplitudes of the optical signal and modulated phases of the optical signal to the beam splitter.

In at least one aspect, the disclosure encompasses the method described herein and which further comprises transmitting, by the controller, the optical signal through a fixed-weight photonic component.

Further, in at least one aspect, the method described herein further comprises (a) disposing the beam splitter on a substrate; and (b) disposing the first photodetector and the second photodetector in free space.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims. Like reference numbers and designations in the various drawings indicate like elements.

FIGS. 1A, 1, and 1C illustrate a time-multiplexed photonic matrix-matrix multiplier (MMM) architecture according to an example implementation.

FIGS. 2A and 2B illustrate a loss-compensated fan-out design according to an example implementation.

FIGS. 3A, 3B, and 3C illustrate the influence of matrix and crossbar dimensions on computing efficiency according to an example implementation.

FIGS. 4A, 4B, 4C, and 4D illustrate a comparison of fixed-weight versus time-multiplexed architectures for matrix-matrix multiplication according to an example implementation.

FIGS. 5A, 5B, 5C, and 5D illustrate an overview of a mixed-architecture implementation for a convolutional neural network (CNN) according to an example implementation.

FIG. 5E illustrates a fixed-weight photonic matrix-vector multiplier according to an example implementation.

FIG. 5F illustrates a time-multiplexed photonic matrix-vector multiplier according to an example implementation.

FIG. 5G illustrates a schematic of a 3D convolutional layer according to an example implementation.

FIG. 5H illustrates a schematic of a time-multiplied matrix according to an example implementation.

FIG. 6A illustrates a 3D integration of an image sensor and photonic matrix-matrix multiplier according to an example implementation.

FIG. 6B illustrates a 3D integration using a polarizing beam splitter and dual image sensor for improved throughput according to an example implementation.

FIG. 7 illustrates a method of performing vector operations according to an example implementation.

FIG. 8 illustrates all-optical convolutions according to an example implementation.

FIG. 9A illustrates a photonic dot-product prototype according to an example implementation.

FIG. 9B illustrates a plot of measured a×b vs expected a×b according to an example implementation.

FIG. 10 illustrates a schematic of temporal correlation using a coherent crossbar array according to an example implementation.

FIG. 11 illustrates a schematic of temporal correlation using a coherent crossbar array according to an example implementation.

### DETAILED DESCRIPTION

Following below are more detailed descriptions of various concepts related to, and implementations of, methods, apparatuses, and systems for an integrated photonic platform to implement vector operations (e.g., large-scale matrix-matrix multiplication). The various concepts introduced above and discussed in greater detail below may be implemented in any of a number of ways, as the described concepts are not limited to any particular manner of implementation. Examples of specific implementations and applications are provided primarily for illustrative purposes.

Advances in artificial intelligence (AI) through the development of deep neural networks (DNNs) have transformed a broad range of disciplines such as medical imaging and diagnostics, materials discovery, autonomous navigation, and natural language processing. DNNs are associated with significant computing resources. The relative degree of generality or specificity of DNNs can scale with the amount of training data and available computation. To improve the accuracy of a DNN by two times, approximately five hundred times more computing power (e.g., number of electrical pulses a processer sends per second, computing power) can be needed. In some examples, the computational resources needed to train state-of-the-art (e.g., control) DNNs has grown by more than about 300,000 times in the past five years, whereas computing efficiency has grown by merely about 10 times. While graphics processors (GPUs) facilitate continued advances in deep learning, this is due to their suitability for distributed training of DNNs across large clusters of individual nodes, rather than significantly improving computational throughput of a single node. A distributed approach to deep learning development may be protracted, incur significant costs, and expel hundreds of tons of CO₂ to train a complex DNN. Such factors impair the economic and environmental sustainability of continued progress in the field of deep learning using conventional computing hardware.

Furthermore, efficient processing of information in the electronic domain can be limited by resistive heating, crosstalk, and capacitance. Capacitance may dominate energy consumption and limit the maximum operating speeds in neural network accelerators to approximately 1 GHz. The operating speed can be limited because the movement of data (e.g., the network weights and training data), rather than arithmetic operations, can require charging and discharging of chip-level metal interconnects. Thus, improving the efficiency of logic gates at the device level can provide diminishing returns and may not sufficiently address the flow of data during computation. Computing in the optical domain can be one approach to overcome the energy-bandwidth trade-off intrinsic to electronic deep learning hardware.

Additionally, optical interconnects can have two fundamental advantages over their electrical counterparts: (1) energy consumption is independent of the modulated signal in the waveguide enabling extremely high modulation frequencies (greater than about 100 GHz) and (2) weak photon-photon interactions allow high bandwidth density through frequency multiplexing. Additionally, by being free from the confines of binary logic and encoding, large-scale linear operations, which can form the major computational bottleneck in DNNs (e.g., convolutions, matrix multiplications, Fourier transforms, random projections, etc.), can be reduced to a single optical transmission measurement with ultra-low energy consumption in lossless materials. The combined advantages of analog computing in the optical domain can enable the dramatic scaling for continued innovations in deep learning in terms of computational density (e.g., operations per chip area) and energy efficiency (e.g., operations per watt).

Further still, various photonic architectures, such as cascaded Mach-Zehnder interferometers (MZIs), in-memory computing, reconfigurable metasurfaces, frequency comb shaping, and neuromorphic computing, show the feasibility of analog computing in the photonic domain. However, the majority of these approaches rely on fixed photonic weights and high-speed photodetectors and analog-to-digital converters (ADCs) to convert the results of an optical matrix-vector multiplication (MVM) back into the digital domain for further processing. Therefore, the opto-electronic readout circuitry can operate at the same speed as the electro-optical modulators at the input. This can place an upper limit on the overall computing speed and energy efficiency of the photonic accelerator. Additionally, unlike digital-to-analog conversion, which can be highly efficient, conversion from the analog to digital domain can be nontrivial and energy consumption can scale with the operation frequency of the ADC. Therefore, the overall energy consumption of the readout circuitry, which can be a large fraction of the overall power consumption of analog computing systems, can roughly scale as approximately N×f, where N is the number of optical output channels and f is the ADC operating speed.

To address such challenges, according to at least one implementation, a method for achieving large-scale, multiply-accumulate operations in the optical domain via homodyne detection is disclosed herein. This approach has several benefits: (1) it can decouple the modulation speed of the optical input channels from the speed of the electrical readout circuitry, (2) the differential nature of homodyne detection can enable both positive and negative numbers (e.g., [symbol] ∈[−1, 1]) to be implemented by controlling the phase and amplitude of two coherent optical inputs, (3) homodyne detection can remove common-mode noise which allows the use of low optical powers that approach the standard quantum limit determined by the photodetector shot noise, and (4) the system can be scalable to very large matrix operations by multiplexing multiply-accumulate operations in space and time.

According to at least one implementation, the above benefits are realizable despite various challenges as described herein. In particular, implementation using free space optics can be challenging since the optical path of the two beams must be both spatially and temporally coherent. Additionally, the spatial light modulators (SLMs) needed to encode matrix values in such a free space architecture can be limited to modulation speeds of approximately 1 kHz or less.

The systems and methods of the present disclosure are directed to an integrated photonic platform configured to use a time-multiplexed architecture. The integrated photonic platform is configured to implement large-scale matrix-matrix multiplication (MMM) which can overcome both phase-matching and modulation challenges of a free space approach. The platform can include an array of waveguide crossings, directional couplers, and balanced photodetection to achieve fan-out and coherent interference of optical signals on-chip. The design of the platform can use robust components which are suited for large scale fabrication in a photonics foundry and can be fully integrated on a hybrid photonic-electronic platform. In addition to de-coupling the high-speed electrical read-out from the data modulation rate, both matrices are encodable in the optical input signals. This can remove the costly reprogramming step utilized by many other photonics approaches.

The systems and methods of the present disclosure can combine the advantages of photonics and electronics to maximize the overall computational efficiency of deep learning hardware, while minimizing inference latency. This blend of integrated photonics with free-space imaging (e.g., 3D integration) addresses the challenge of creating dense network connectivity on a 2D photonics platform while achieving perfect temporal and spatial optical coherence. Lack of temporal and spatial optical coherence can impair free-space optical computing approaches. Additionally, unlike the majority of analog AI accelerators which implement matrix-vector multiplication in a single clock cycle, the systems and methods of the present disclosure can perform vector-vector dot-products in the time-domain, which allow highly scalable and efficient matrix-matrix multiplication. This approach ameliorates issues with high-speed analog-to-digital conversion of MVM architectures which can be an efficiency and speed bottleneck of analog AI accelerators.

Further, the systems and methods of the present disclosure provide for photonic matrix-matrix multiplication using integrated photonics and one or more CMOS image sensors. An exemplary implementation may employ a hybrid accelerator in connection with fabrication of a coherent photonic array to implement data encoding and fan-out, interfacing with CMOS image sensors for efficient ADC readout, and performing coherent matrix-matrix multiplication using the hardware. Further, at least one implementation may be used to support a simulation framework to model deep learning performance in large-scale photonic circuits. Such a simulation framework may allow for (1) predicting the ultimate performance gains of the approach in DNN models by designing hardware-tailored DNN models for a hybrid accelerator and (2) benchmarking the predicted computational efficiency and latency of the accelerator against control digital and analog AI accelerators. The systems and methods of the present disclosure can improve computational efficiency by greater than approximately 100× (less than approximately 10 fJ/OP) while decreasing inference latency by more than approximately 100× compared to control approaches. Additionally, the systems and methods of the present disclosure can be scalable, use a minimal number of foundry-standard active components, and be naturally robust to fabrication imperfections.

The systems and methods of the present disclosure can include encoding both input matrices in a time-multiplexed optical field. This approach can be advantageous for large scale computations because: (1) it can decouple the input electro-optic modulation rate from the speed of opto-electronic read-out, and (2) it can decouple the size of the input matrices from the physical dimensions of the photonic hardware. Additionally, the coherent photonic architecture can lend itself naturally to electrical readout via a CMOS image sensor which can dramatically simplify the on-chip complexity.

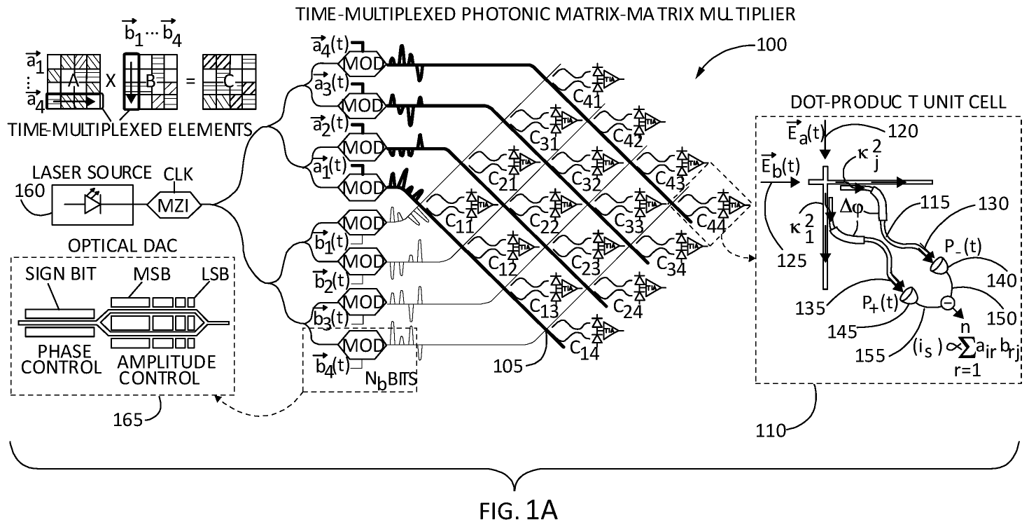

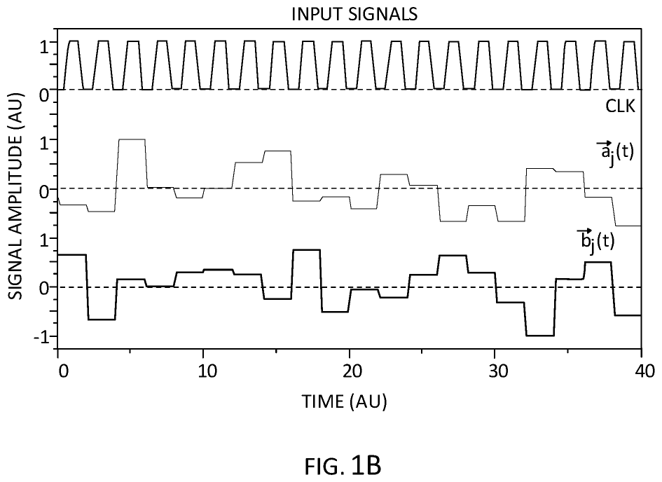

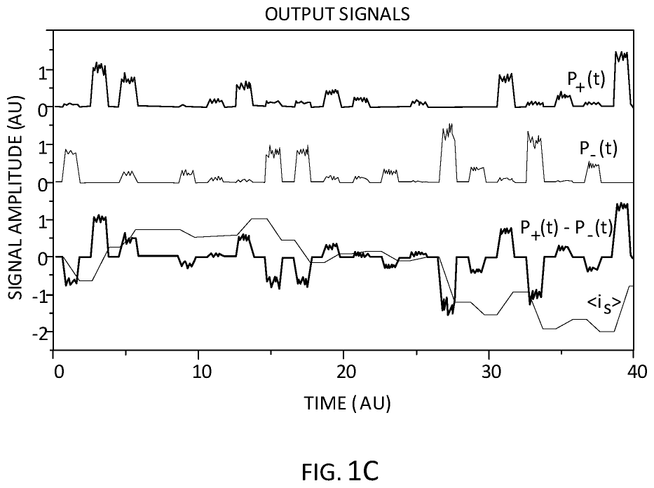

FIGS. 1A-1C illustrate a time-multiplexed photonic matrix-matrix multiplier architecture. FIG. 1A illustrates a schematic of a fully integrated photonic MMM platform capable of multiplying two matrices (e.g., two 4×4 matrices). The photonic MMM platform is configured to multiply two matrices of arbitrary size. Each input of the coherent crossbar array is configured to be modulated in both amplitude and phase (lower left). The intersection of each crossbar is configured such that a photoelectric multiplier unit is present, which yields the dot product between two time-multiplexed optical signals (lower right). FIG. 1B illustrates simulated input signals of a single dot-product unit cell using at least one interconnect (e.g., in a simulation using Lumerical INTERCONNECT made by Ansys, Inc. of Canonsburg, PA). The signs of elements in vectors [symbol] ᵢ(t) and [symbol] ⱼ(t) can be encoded in the optical phase while the magnitudes can be encoded in the field amplitudes. FIG. 1C illustrates simulated output signals of a single dot-product unit cell using the at least one interconnect.

### I. Design of Integrated Photonic Matrix-Matrix Multiplier

The multiplication of two matrices A_{m×n} and B_{n×p} can be the result of mp dot-products between the row vectors of matrix A and the column vectors of matrix B. Thus, each element in the resulting matrix of size m×p can be written as Equation (1):

$${( A B )}_{i j} = {\sum }_{r = 1}^{n} {a}_{ir} {b}_{rj} = {\vec{a}}_{i} \cdot {\vec{b}}_{j} \qquad ( 1 )$$

where [symbol] ᵢ is the i^{th} row of A and [symbol] ⱼ is the j^{th} column of B. If the above summation of products between [symbol] ᵢᵣ and are [symbol] ᵣⱼ are multiplexed in time and scaled such that |aᵢᵣ|, |bᵣⱼ|∈[0,1], this dot product can be computed optically using a balanced homodyne detection scheme as illustrated in FIG. 1A. In this approach, vectors [symbol] ᵢ and [symbol] ⱼ from Equation (1) can be encoded in the time-varying amplitudes of two interfering electric fields [symbol] ₐ(t)=âEₐ(t)e^{iφ}^{ₐ₍ₜ₎} and [symbol] _{b}(t) \hat{b}E_{b}(t)e^{iφ}^{_{b}}^{(t)} incident on a 3 dB directional coupler or a 50:50 beam splitter. Due to conservation of energy, the cross-coupled (or reflected) beam can experience a π/2-phase shift with respect to the transmitted beam. Assuming [symbol] ₐ(t) and [symbol] _{b}(t) are temporally and spatially coherent (e.g., phase-matched and single mode) and of the same polarization, the optical signal measured by the photodetectors at the two output ports of the 3-dB coupler is expressible as Equation (2) and Equation (3):

$${P}_{+} ( t ) = \frac{1}{2} ( {\vert {E}_{a} ( t ) \vert}^{2} + {\vert {E}_{b} ( t ) \vert}^{2} ) + Re [ {E}_{a}^{*} ( t ) {E}_{b} ( t ) ] sin ( Δφ ) \qquad ( 2 )$$

$${P}_{-} ( t ) = \frac{1}{2} ( {\vert {E}_{a} ( t ) \vert}^{2} + {\vert {E}_{b} ( t ) \vert}^{2} ) - Re [ {E}_{a}^{*} ( t ) {E}_{b} ( t ) ] sin ( Δφ ) \qquad ( 3 )$$

where P_{±}(t) is the optical power incident on the two photodetectors and Δφ is the relative phase difference between [symbol] ₐ(t) and [symbol] _{b} (t). From Equation (2) and Equation (3), the first term can be proportional to the optical power of the two input signals, while the second term can contain the product of the field amplitudes which differ by a sign. Optical power can be converted to photocurrent using the photodetector's responsivity,

$$R = \frac{η e}{h v} ,$$

where η is the quantum efficiency of the detector, e is the charge of an electron, and hv is the photon energy. Taking the difference of Equation (2) and Equation (3) allows the first term to be canceled and the second term to remain using balanced photodetection according to Equation (4) and Equation (5):

$$〈 {i}_{s} 〉 = \frac{1}{n τ} \frac{η e}{h v} {\int }_{0}^{n τ} ( {P}_{+} ( t ) - {P}_{-} ( t ) ) dt = \frac{2}{n τ} \frac{ηe}{hv} {\int }_{0}^{n τ} {E}_{a} ( t ) {E}_{b} ( t ) sin ( Δφ ( t ) + {Δφ}^{′} ) dt \qquad ( 4 )$$

$$〈 {i}_{s} 〉 ∝ {\sum }_{r = 1}^{n} {a}_{ir} {b}_{rj} \qquad ( 5 )$$

In Equation (4), [symbol] iₛ [symbol] is the difference signal measured by the homodyne setup, nτ is the total duration of n pulses of period τ=1/f_{mod}, and the fields Eₐ(t) and E_{b}(t) are assumed to be real. Δφ=Δφ(t)+Δφ′ contains both a time-dependent phase difference Δφ(t)=φₐ(t)−φ_{b}(t) and a fixed phase difference based on the relative optical delay between the source of [symbol] ₐ(t) and [symbol] _{b}(t) and the two input ports of the 3 dB directional coupler. Assuming Δφ(t)−qπ (where q is an integer), the difference signal can be maximized by setting Δφ′=±π/2. This can be accomplished with thermo-optic phase tuning, but can also be accomplished using methods which use zero static power, such as laser trimming or low-loss phase change materials. The phase tuning to set Δφ′=±π/2 can be determined experimentally by maximizing (iₛ) while both Eₐ(t) and E_{b}(t) are held constant and the time-dependent phase terms are set to φₐ(t)=φ_{b}(t)=0. Once Δφ′ has been trimmed to the correct relative phase difference, the amplitude and phase modulators at each of the inputs can be modulated such that Equation (5) is satisfied.

In some implementations, to compute the dot-product between two vectors, the vector elements can be encoded in the optical fields. Using a balanced homodyne detection approach as detailed above, all real-value numbers in the range [−1, 1] can be encoded by modulating both the phase and amplitude of the optical signals. Amplitude modulation can be achieved with integrated high-frequency modulators (e.g., silicon plasma-dispersion MZI or microring modulators). While micro-ring modulators can be desirable for efficient and compact modulation, they can also impart a nonlinear phase on the modulated signal which may be correctible through special compensation (e.g., two cascaded ring modulators). A balanced MZI modulator based on carrier depletion can be modulated with complementary voltages in both arms and therefore minimize phase modulation of the output optical signal. Additionally, both MZI and ring modulators with built-in digital to analog converters (DACs) can efficiently convert a digital input into an amplitude modulated optical output. A highly linear 4-bit optical DAC capable of approximately 40 Gb/s and with an efficiency of approximately 42 f/bit using a segmented silicon micro-ring modulator may be used. This approach allows for high-speed electro-optical and digital-to-analog conversion without additional circuitry, which may reduce the overall efficiency of the optical computing approach.

From Equation (4), the homodyne signal is proportional to sin(Δφ(t)+Δφ′), where Δφ=±π/2 does not vary with the optical signal. Therefore, by modulating φₐ(t) and φ_{b}(t) to either 0 or π, both positive and negative numbers can be encoded. This can be achieved by cascading an additional phase modulator with each amplitude modulator (e.g., see “Optical DAC” in FIG. 1A). Adding this phase term can increase the total number of symbols that can be encoded by two times without placing additional requirements on the amplitude modulator (e.g., 5-bit signed integers in the case of a PAM-16 modulator in series with a phase modulator). To minimize the effects of the rise and fall times of the amplitude and phase modulators, an additional intensity modulator can be added immediately after the optical source to globally gate the optical signal during transitions (e.g., see “CLK” signal in FIG. 1).

In some implementations, the device 100 (e.g., photonic circuit, time-multiplexed architecture, mixed-architecture, hybrid architecture, photonic matrix-matrix multiplier, coherent photonic architecture, hybrid photonic-electronic computing architecture, etc.) can perform vector operations. The device 100 can include a photonic crossbar array 105. The photonic crossbar array 105 can include a plurality of unit cells 110 (e.g., dot-product unit cell). One or more of the plurality of unit cells 110 can include a beam splitter 115. The beam splitter 115 can receive a first input 120 of an optical signal and a second input 125 of the optical signal. The optical signal can encode matrix elements of at least one of a tensor, a matrix, or a vector. The first input 120 and the second input 125 can be temporally and spatially coherent. The beam splitter 115 can output a first output 130 of the optical signal and a second output 135 of the optical signal. The beam splitter 115 can include at least one of an approximately 3 dB directional coupler, a 50:50 beam splitter, or a multimode interferometer. The beam splitter 115 may be disposed on a substrate (e.g., chip, microchip, electronic package, board, etc.). The device 100 can include a plurality of beam splitters 115.

In some implementations, the one or more of the plurality of unit cells 110 can include a first photodetector 140 configured to receive the first output 130 of the optical signal and generate a third output 150 of the optical signal. The third output 150 of the optical signal can include a photocurrent from the first photodetector 140. The third output 150 of the optical signal can include an electrical voltage from the first photodetector 140. The first input 120 and the second input 125 can interfere constructively or destructively on the first photodetector 140. The one or more of the plurality of unit cells 110 can include a second photodetector 145 configured to receive the second output 135 of the optical signal and generate a fourth output 155 of the optical signal. The fourth output 155 of the optical signal can include a photocurrent from the second photodetector 145. The fourth output 155 of the optical signal can include an electrical voltage from the second photodetector 145. The first input 120 and the second input 125 can interfere constructively or destructively on the second photodetector 145. The one or more unit cells 110 can output, as a unit cell output, the third output 150 of the optical signal and the fourth output 155 of the optical signal. The first photodetector 140 can be disposed on a substrate. The second photodetector 145 can be disposed on a substrate. The beam splitter 115, the first photodetector 140, and the second photodetector 145 can be disposed on a substrate (e.g., the same substrate, or multiple substrates). The beam splitter 115 can be disposed on a substrate while the first photodetector 140 and the second photodetector 145 are disposed in free space (e.g., off-substrate, not on the substrate, removed from the substrate, etc.).

In some implementations, the device 100 may include a controller. The controller is configured to encode a first vector in time-varying amplitudes of a first electric field. The controller is configured to encode a second vector in time-varying amplitudes of a second electric field. The controller is configured to determine a result of multiplication of the first vector and the second vector based on the unit cell output from the one or more of the plurality of unit cells 110. The controller is configured to determine a result of multiplication of a first matrix and a second matrix. The device 100 can include a light source 160 (e.g., optical source). The device 100 can include a plurality of light sources with unique optical frequencies. The plurality of light sources can pass through the photonic crossbar array 105 and the plurality of unit cells 110. The inputs and outputs can be filtered using wavelength division multiplexing. The light source (emitter) 160 is configured to transmit the optical signal. The light source 160 can include a laser (e.g., laser source).

In some implementations, the device 100 is configured to include a plurality of modulators 165. The plurality of modulators 165 are configured to be coupled with the photonic crossbar array 105. One or more of the plurality of modulators 165 are configured to receive the optical signal from the light source 160. The one or more of the plurality of modulators 165 are configured to modulate amplitudes of the optical signal. The one or more of the plurality of modulators 165 are configured to modulate phases of the optical signal. The one or more of the plurality of modulators 165 are configured to transmit the modulated amplitudes of the optical signal to the beam splitter 115. The one or more of the plurality of modulators 165 are configured to transmit the modulated phases of the optical signal to the beam splitter 115. The one or more of the plurality of modulators 165 are configured to include amplitude-only modulators. The amplitude-only modulators are configured to encode amplitudes of matrix vector elements. The one or more of the plurality of modulators 165 are configured to include phase-only modulators. The phase-only modulators are configured to encode positive and negative numbers. Each modulator of the plurality of modulators 165 can be distributed to the plurality of unit cells 110.

In some implementations, the device 100 is configured to include an intensity modulator. The intensity modulator is configured to receive optical signals from a light source 160. The intensity modulator is configured to modulate the amplitudes of the optical signal. The intensity modulator is configured to transmit modulated amplitudes of the optical signal to a plurality of modulators 165. The intensity modulator can be configured to include a balanced Mach-Zehnder Interferometer (MZI) modulator or configured to include a ring resonator modulator. The MZI modulator can be configured to encode amplitudes of matrix vector elements and/or phases of matrix vector elements.

In some implementations, the device 100 can include fixed-weight photonic hardware. The device 100 can include a hybrid architecture. The hybrid architecture is configured to include a time-multiplexed architecture and a fixed-weight architecture. The hybrid architecture is configured to include fixed-weight photonic hardware (e.g., a hardware component). The fixed-weight photonic hardware can include phase-change memory cells, Mach-Zehnder Interferometers, or micro-ring resonators to encode optical weights.

In some implementations, the device 100 can be multiplexed in wavelength (e.g., wavelength-multiplexed) and multiplexed in time (e.g., time-multiplexed). The device 100 can include a plurality of optical sources. The device 100 can include the plurality of optical sources with on-chip filtering at a plurality of inputs of the plurality of modulators 165. The device 100 can include the plurality of optical sources with on-chip filtering at a plurality of outputs of a plurality of photodetectors (e.g., first photodetector 140, second photodetector 145). The device 100 can include the plurality of optical sources with off-chip filtering at the plurality of inputs of the plurality of modulators 165. The device 100 can include the plurality of optical sources with off-chip filtering at the plurality of outputs of the plurality of photodetectors.

In some implementations, the device 100 can include a plurality of the beam splitters 115. The device 100 can include a light emitter. The light emitter can be configured to transmit the optical signal. The device 100 can include a plurality of modulators. The modulators can be coupled with the photonic crossbar array. One or more of the plurality of modulators can receive the optical signal from the light emitter. The one or more of the plurality of modulators can modulate amplitudes of the optical signal. The one or more of the plurality of modulators can modulate phases of the optical signal. The one or more of the plurality of modulators can transmit the modulated amplitudes of the optical signal and modulated phases of the optical signal to one or more of the plurality of beam splitters.

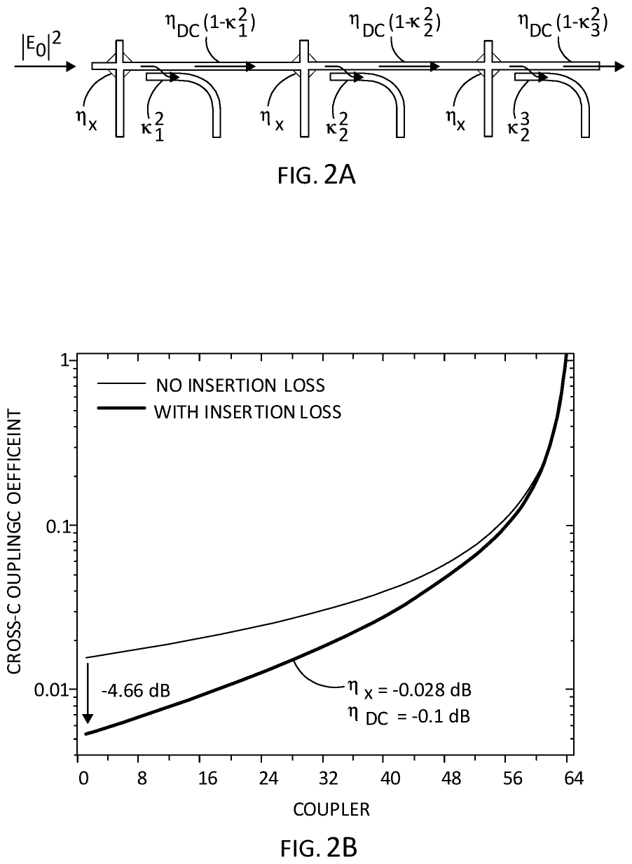

FIGS. 2A and 2B illustrate a loss-compensated fan-out design according to some implementations. A method to allow for equal power distribution to each dot product unit cell within the array using a photonic crossbar architecture for fan-out is described. FIG. 2A illustrates the parameters which define the cross-coupling coefficients (kₙ²) and the transmission of a single directional coupler (η_{DC}) and waveguide crossing (ηₓ). FIG. 2A illustrates the first three unit cells of the crossbar array in a given row. Insertion losses of the crossbar and directional couplers (ηₓ and η_{DC}, respectively) can be accounted for in the cross-coupling coefficients (kᵢ²). The insertion loss for the directional coupler can be independent of coupling length (e.g., absorption and scattering in the coupling region can be negligible compared to mode-mismatch). To have equal power distribution from the input waveguide to each unit cell in a given row, Equation (6) can be true:

$${\vert {E}_{0} \vert}^{2} {η}_{x} {κ}_{1}^{2} = {\vert {E}_{0} \vert}^{2} {η}_{x}^{2} {η}_{D C} ( 1 - {κ}_{1}^{2} ) {κ}_{2}^{2} = {\vert {E}_{0} \vert}^{2} {η}_{x}^{3} {η}_{D C}^{2} ( 1 - {κ}_{1}^{2} ) ( 1 - {κ}_{2}^{2} ) {κ}_{3}^{2} \qquad ( 6 )$$

This can lead to the following relationship between two neighboring directional couplers as shown in Equation (7):

$${κ}_{n}^{2} = \frac{{κ}_{n + 1}^{2}}{\frac{1}{{η}_{IL}} + {κ}_{n + 1}^{2}} \qquad ( 7 )$$

where η_{IL}=η×η_{DC} is the insertion loss of each unit cell and can be modified to include the waveguide loss as well (e.g., η_{IL}=ηₓη_{DC}^{e}^{^{−α}}^{loss}^{^{L}}). Equation (7) can hold true for equal power distribution along a column. If the total number of unit cells in a given row or column is N, then the final cross coupling term can be set to k_{N}²=1 and Equation (7) can be solved for all previous coupling coefficients recursively. k_{N}²=0.5 can be chosen if the output of the final coupler through port is used to calibrate the average insertion loss of a given row or column. This design choice can be used to experimentally determine the average unit cell transmission η̅_̅{̅I̅L̅}̅ after fabrication.

The coupling coefficients for an ideal array (η_{IL}=1) and an array with realistic loss are shown in FIG. 2B for an array with 64 unit cells in a row. FIG. 2B illustrates the calculated cross-coupling coefficients for a 64×64 crossbar array using experimentally measured insertion losses.

In some implementations, matrix-matrix multiplication between A_{m×n} and B_{n×p} can be performed using a photonic crossbar array as described above with k×k unit cells. Using the crossbar architecture, each unit cell of the crossbar can perform the dot product (AB)ᵢⱼ=\vec{a}ₗ, \vec{b}ⱼ, where i and j are the row and column index of the unit cell (FIG. 1A). From Equation (4), the time required to perform each dot product can be dependent on the modulation speed and the number of elements in the vectors \vec{aₗ} and \vec{bⱼ}. k² dot products can be performed in parallel. Thus, if k≥m, p, the operation A×B=C can have a time complexity of O(n). Compared to matrix multiplication in the digital domain, which scales between O(n³) and O(n^{2.373}) for two square matrices of size n×n, the linear scaling of the systems and methods of the present disclosure demonstrate the significant speed advantage of computing in the analog domain. While the compute time of matrix-vector operations can scale as O(1) for both optical and electrical in-memory computing approaches, the output of the present crossbar array can be a full k×k matrix rather than a single vector of length k. Thus, the operation A_{m×n}×B_{n×p} can scale as O(p) for an in-memory architecture where A_{m×n} is a memory array of fixed weights. Frequency multiplexing approaches in both the optical and electrical domains can reduce this to

$$O ( ⌈ \frac{p}{d} ⌉ ) ,$$

where dis the number of frequency channels used simultaneously.

In the scenario that m, p>k, the time complexity can become approximately

$$O ( n ⌈ \frac{m}{k} ⌉ ⌈ \frac{p}{k} ⌉ )$$

for a single crossbar array. In this case, A_{m×n}×B_{n×p} can be subdivided into

$$⌈ \frac{m}{k} ⌉ ⌈ \frac{p}{k} ⌉$$

sequential operations of size A_{k×n}×B_{n×k} to match the dimensions of the photonic crossbar. Since these operations can be independent from one another, they can be parallelized across multiple crossbar arrays to reduce the time complexity back to O(n). Unlike a fixed-matrix approach which can place an upper limit of n≤k for a k×k array of weights, k×n weights can be encoded in the time-domain such that n is no longer limited by physical hardware (i.e., n>>k). This can have implications on both computational efficiency and latency.

DNNs using complex weights can benefit from faster convergence, stronger generalization, and greater representation complexity. However, the added computational overhead of performing complex operations can cause limited interest in adopting this approach. Complex matrix operations can be performed using the present photonic architecture. The product of two complex matrices can be written in terms of their real-valued elements as Equation (8):

$$\tilde{A} \tilde{B} = ( {A}_{R e} + i {A}_{Im} ) ( {B}_{R e} + i {B}_{Im} ) = {A}_{R e} {B}_{R e} - {A}_{Im} {B}_{Im} + i ( {A}_{R e} {B}_{Im} + {A}_{Im} {B}_{R e} ) \qquad ( 8 )$$

where the matrices A_{Re}, B_{Re}, A_{Im}, B_{Im}∈ [symbol] contain the real-valued elements of the complex matrices Ã, \tilde{B}∈ [symbol] . Thus the multiplication of any two complex matrices can be accomplished by four sequential real-valued matrix-matrix multiplications. While this can increase computational time by a factor of four times, complex arithmetic can be performed in the optical domain by making full use of the amplitude and phase. To implement this in the present architecture, some implementations may utilize continuous phase and amplitude modulation (such as integrating two phase modulators implementing quadrature-amplitude modulation) and coherent detection of both the amplitude and phase using two balanced homodyne detectors.

### H. Noise Analysis

The computational precision of any analog computing system can be limited by the signal-to-noise ratio (SNR). The minimum acceptable SNR can be dependent on the application. Neural networks can be relatively robust to unstructured noise and can benefit from added noise in the case of limited precision. In the case of analog computing systems that are applied to machine learning problems, fixed precision arithmetic can be used. Therefore, if an output precision of N_{b} bits is needed, the minimum SNR of system can be defined as Equation (9):

$${SNR}^{2} = {2}^{2 {N}_{b}} = \frac{〈 {i}_{s}^{2} 〉}{2 e ( 〈 {i}_{S N} 〉 + 〈 {i}_{D} 〉 ) Δ f + 〈 {i}_{R N}^{2} 〉} \qquad ( 9 )$$

where [symbol] iₛ² [symbol] is the mean square value of the measured homodyne photocurrent, [symbol] i_{SN} [symbol] is the photocurrent due to photon shot noise, [symbol] i_{D} [symbol] is the dark current of the photodetector, Δf is the bandwidth of the read-out circuitry, and [symbol] i_{RN}² [symbol] is the noise of the read-out circuitry (e.g., including Johnson noise, 1/f noise from amplifier, etc.). If the measurement is assumed to be limited by shot noise, then [symbol] i_{SN} [symbol] >> [symbol] i_{D} [symbol] and

$$\frac{〈 {i}_{R N}^{2} 〉}{2 e Δ f} .$$

This can be reasonable in the case of well-designed read-out circuitry and for

$${i}_{D} ≪ \frac{η e}{h v} {\overline{P}}_{\pm } ,$$

where P̅_{±} is the average power incident on each photodetector. The photocurrent due to shot noise can be written as Equation (10):

$$\begin{matrix}{〈 {i}_{S N} 〉 = \frac{1}{n τ} \frac{η e}{h v} {\int }_{0}^{n τ} ( {P}_{+} ( t ) + {P}_{-} ( t ) ) d t = \frac{1}{n τ} \frac{η e}{h v} {\int }_{0}^{n τ} ( {\vert {E}_{a} ( t ) \vert}^{2} + {E}_{b} ( t ) \vert}^{2} ) dt \\ 〈 {i}_{S N} 〉 = \frac{η e}{h v} ( {\overline{P}}_{a} + {\overline{P}}_{b} )\end{matrix} \qquad ( 10 )$$

where P̅ₐ and P̅_{b} are the time-averaged optical powers of the two input signals. The photocurrent due to optical shot noise can be dependent on the total optical power used to compute the dot product. Combining Equations (4), (9), and (10), Equation (11) follows:

$$\frac{h v}{2 η} ( {\overline{P}}_{a} + {\overline{P}}_{b} ) Δ f \cdot {2}^{2 {N}_{b}} = {[ {\int }_{0}^{n τ} \frac{{E}_{a} ( t ) {E}_{b} ( t )}{n τ} d t ]}^{2} \qquad ( 11 )$$

where the term sin(Δφ(t)+Δφ′) has been removed by setting Δϕ′=±π/2 and requiring Δφ(t)=0 or π. This can be equivalent to restricting the normalized electric field amplitude to [symbol] [−1, 1] which is the real number encoding system as defined above. By modulating the intensity of the optical source using a clock signal, it can be assumed that any transition effects can be mitigated due to modulating Eₐ(t) and E_{b}(t) such that their values are constant over the duration of a single pulse (see simulation results of FIGS. 1B and 1C). Thus, Eₐ(t) and E_{b}(t) can be represented by the discrete variables a; and b; normalized by the maximum field amplitude such that the integral in Equation (11) becomes a summation defined by Equation (12):

$${[ {\int }_{0}^{n τ} \frac{{E}_{a} ( t ) {E}_{b} ( t )}{n τ} d t ]}^{2} = {max ( {\vert {E}_{a} \vert}^{2} {\vert {E}_{b} \vert}^{2} ) [ \frac{1}{n} {\sum }_{i = 1}^{n} {a}_{i} {b}_{i} ]}^{2} \qquad ( 12 )$$

The distribution of the discrete variables aᵢ and bᵢ can have an impact on the SNR measured at the output. If the restriction aᵢ, bᵢ∈ [symbol] [0, 1] applies, the product of aᵢbᵢ can always be a positive value. Thus, assuming a; and b; are independent random variables with a mean value of āᵢ=b̅ᵢ=0.5, the expected value of Equation (12) can be defined by Equation (13):

$$E ( {max ( {\vert {E}_{a} \vert}^{2} {\vert {E}_{b} \vert}^{2} ) [ \frac{1}{{N}^{′}} {\sum }_{i = 1}^{{N}^{′}} {a}_{i} {b}_{i} ]}^{2} ) = {\overline{P}}_{a} {\overline{P}}_{b} \qquad ( 13 )$$

where max (|E_{a,b}|²)=4P̅_{a,b} has been replaced, which is the average optical power in each signal if āᵢ=b̅ᵢ=0.5. The SNR can be maximized when (P̅ₐ=P̅_{b}). Therefore, the minimum average optical power required to resolve the dot product of two vectors with positive, random inputs can be defined by Equation (14):

$${\overline{P}}_{min} = \frac{h v}{η} \cdot Δ f \cdot {2}^{2 {N}_{b}} = \frac{h v}{η} \cdot \frac{{f}_{m o d}}{n} \cdot {2}^{2 {N}_{b}} ( 0 \leq {a}_{i} {b}_{i} \leq 1 ) \qquad ( 14 )$$

As appreciated from Equation (14), the minimum optical power can be proportional to the measurement bandwidth Δf=f_{mod}/n. Therefore, a longer integration time (e.g., longer input vector) can require less optical power per multiply-accumulate (MAC) operation. If the average optical energy per MAC operation is solved for, Equation (15) is defined:

$${E}_{m a c} = \frac{{P}_{min}}{{f}_{m o d}} = \frac{h v}{n} \cdot \frac{{2}^{2 {N}_{b}}}{n} ( 0 \leq {a}_{i} {b}_{i} \leq 1 ) \qquad ( 15 )$$

Similar to implementations with electronic crossbar arrays, the total noise limited optical energy required to compute the dot product [symbol] ᵢ·bⱼ is not necessarily dependent on the input vector size for fixed precision arithmetic. The derived minimum optical power in Equation (15) can be compared to that of n incoherent MAC operations using a single photodetector. Assuming input vector [symbol] is encoded on the optical power and [symbol] on the optical transmission of the network (e.g., microring resonators or optical phase-change memory) and āᵢ=b̅ᵢ=0.5, Equations (14) and (15) become Equation (16):

$${\overline{P}}_{min} = \frac{4 hv}{η} \frac{{f}_{m o d}}{n} \cdot {2}^{2 {N}_{b}} , {\overline{E}}_{M A C} = \frac{4 h v}{η} \frac{{2}^{2 {N}_{b}}}{n} ( 0 \leq {a}_{i} {b}_{i} \leq 1 ) \qquad ( 16 )$$

which is approximately four times larger than the coherent case. The reasons for this are as follows. First, there can be approximately a twofold improvement in SNR using homodyne detection. Second, multiplication can be performed using the optical field rather than the optical intensity resulting in an average two times greater contribution to the signal photocurrent compared to the shot noise. However, for analog computing approaches the optical power can be dwarfed by the power consumption of the readout electronics (especially the ADC) which can scale approximately linearly with the sampling rate. Thus, reducing the ADC operation frequency by 1/n can result in the largest energy savings of the systems and methods of the present disclosure Equation (16) can be a factor of 4 times larger than the lower bound for an incoherent photonic MAC architecture. The expected value of two random input vectors can be resolved to N_{b} bits of precision, rather than the maximum signal possible (i.e., aᵢ=bᵢ=1 for all i).

Using both phase and intensity modulation, a; and b; can be both positive and negative such that the product aᵢbᵢ∈ [symbol] [−1, 1]. For the case of deep neural networks, it can be assumed that the data passing between layers is positive after the activation function (e.g., ReLU, softmax, etc.), while the connectivity matrix is normally distributed within [symbol] [−1, 1] with a mean of zero (bᵢ˜N(0, σ_{b})). From the law of expectations, the average product of a̅ₗ̅b̅ₗ̅ and the signal [symbol] iₛ² [symbol] can sum to zero on average. In this case, the variance (rather than the mean) of Σaᵢbᵢ can be resolved to N_{b} bits of resolution. If aᵢ and bᵢ are independent random variables, Equation (17) can be defined:

$$Var ( \frac{max ( \vert {E}_{a} \vert \vert {E}_{b} \vert )}{n} {\sum }_{i = 1}^{n} {a}_{i} {b}_{i} ) = \frac{max ( {\vert {E}_{a} \vert}^{2} {\vert {E}_{b} \vert}^{2} )}{{2}^{n}} {\sum }_{i = 1}^{n} Var ( {a}_{i} {b}_{i} ) = 16 \frac{{\overline{P}}_{a} {\overline{P}}_{b}}{n} ( {\overline{a}}_{i}^{2} + {σ}_{a}^{2} ) {σ}_{b}^{2} ( for {\overline{b}}_{i} = 0 ) \qquad ( 17 )$$

where σₐ² and σ_{b}² are the variance of aᵢ and bᵢ, respectively. If σ_{b}=0.5 and aᵢ is uniformly distributed on the interval [0, 1], āᵢ=0.5 and σₐ²=1/12 so Equation (18) can be defined:

$$Var ( \frac{max ( \vert {E}_{a} \vert \vert {E}_{b} \vert )}{n} {\sum }_{i = 1}^{n} {a}_{i} {b}_{i} ) = \frac{4 {\overline{P}}_{a} {\overline{P}}_{b}}{3 n} \qquad ( 18 )$$

Setting P̅ₐ=P̅_{b} to maximize SNR, the expressions for the minimum average optical power and average optical energy per MAC operation can be defined as Equations (19-a) and (19-b):

$${\overline{P}}_{min} = \frac{4 h v}{3 η} n Δ f \cdot {2}^{2 {N}_{b}} = \frac{4 h v}{3 η} {f}_{m o d} \cdot {2}^{2 {N}_{b}} ( - 1 \leq {a}_{i} {b}_{i} \leq 1 ) \qquad ( 19 - a )$$

$${\overline{E}}_{MAC} = \frac{{\overline{P}}_{min}}{{f}_{m o d}} = \frac{4 h v}{3 η} \cdot {2}^{2 {N}_{b}} \qquad ( 19 - b )$$

Unlike the case for aᵢbᵢ∈[0,1], the average optical energy per MAC operation does not depend on the length of the input vectors aᵢ and bᵢ. Thus, the optical energy required to compute the dot product between two vectors within the range of [−1,1] can scale linearly with the input vector size, n. In some implementations, to address this issue, two dot products (assuming [symbol] ᵢ is positive) are performed instead of one such that the input vectors [symbol] ᵢ, [symbol] ⱼ⁺, [symbol] ⱼ⁻∈[0,1] are all positive numbers: [symbol] ᵢ· [symbol] ⱼ= [symbol] ᵢ· [symbol] ⱼ⁺− [symbol] ᵢ· [symbol] ⱼ⁻. Such implementations reduce the energy consumption for large input vectors but do so while doubling either the computation time or hardware footprint. The optical power and energy of analog photonic processors can scale as 2^{3N}^{_{b}} rather than 2^{2N}^{_{b}} in the shot-noise-limited regime.

### III. Energy and Compute Density Analysis

According to at least one implementation, the total energy consumption and computing efficiency of the present photonic crossbar array can be estimated. Using an externally modulated continuous-wave laser source, the minimum total optical power to overcome the quantum limited shot noise for positive valued inputs can be defined by Equation (20):

$${p}_{min}^{optical} \geq \frac{4 h v {f}_{m o d}}{{η}_{m o d}^{2} {η}_{P D} {η}_{x} {κ}_{1}^{2}} ( \frac{k}{n} ) \cdot {2}^{2 {N}_{b}} \approx \frac{4 h v {f}_{m o d}}{{η}_{m o d}^{2} {η}_{P D}} ( \frac{{k}^{2}}{n} ) \cdot {2}^{2 {N}_{b}} \qquad ( 20 )$$

where η_{mod} is the transmission of the clock and input optical modulators, η_{PD} is the quantum efficiency of the photodetectors, ηₓk₁² is the fraction of power coupled into the first unit cell (defined in Equations (6) and (7)), and k×k is the size of the crossbar array. The extra factor of four times can arise from the fact that while the average power is |E_{a,b}/2|², the maximum power required to cover the full range [0,1] can be |E_{a,b}|²=4P̅ₘᵢₙ. In the ideal case of lossless passive components, ηₓk₁²≈1/k to account for fan-out. The total power required to operate the crossbar array can be defined by Equation (21):

$${P}_{total} \approx ( \frac{{k}^{2}}{n} ) \cdot \frac{4 h v {f}_{m o d}}{{η}_{total}} \cdot {2}^{2 {N}_{b}} + ( 2 k + 1 ) \cdot {P}_{m o d}^{E / O} + {k}^{2} \cdot {P}_{read}^{O / E} \qquad ( 21 )$$

where ηₜₒₜₐₗ=η_{mod}²η_{PD}ηₗₐₛₑᵣ includes the laser wall plug efficiency (typically assumed to be approximately 20%), P_{mod}^{E/O} is the power consumption of each modulator, and P_{read}^{E/O} is the electrical power necessary to read-out a single dot-product unit cell including analog to digital conversion.

In at least one implementation, k² balanced photodetector units with accompanying readout circuitry are provided. In such implementations, the readout rate is f_{mod}/n and therefore the readout power can scale linearly with crossbar dimension k if k≈n. The energy consumption per MAC operation for the entire crossbar array can be calculated and defined by Equation (22):

$${E}_{M A C} = \frac{{P}_{t o t a l}}{\# MAC / s} \approx \frac{1}{n} \cdot \frac{4 h v}{{η}_{t o t a l}} \cdot {2}^{2 {N}_{b}} + \frac{( 2 k + 1 )}{{k}^{2}} \cdot {β}_{m o d} {N}_{b} + \frac{1}{n} \cdot {E}_{read}^{O / E} \qquad ( 22 )$$

$$where {β}_{m o d} {N}_{b} {f}_{m o d} = {P}_{m o d}^{E / O} , {E}_{τ e a d}^{O / E} \cdot \frac{{f}_{m o d}}{n} = {P}_{read}^{O / E} ,$$

and β_{mod} is the modulation efficiency in J/bit. Since E_{MAC} can be inversely proportional to both k and n, larger matrix operations can result in the larger energy savings due to the advantages of fan-out and choice of fixed-precision operations.

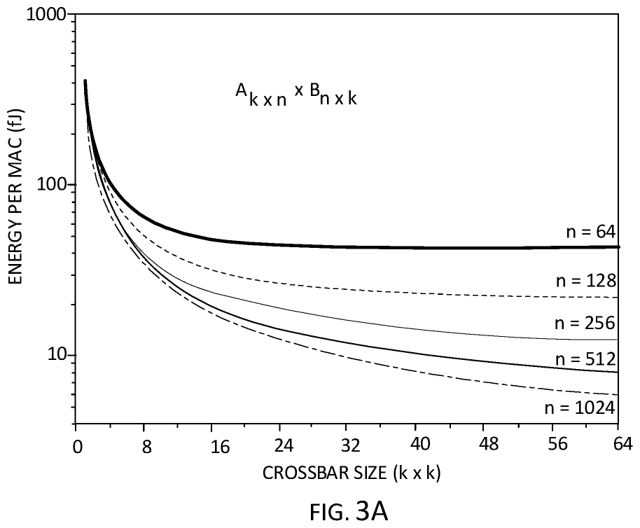

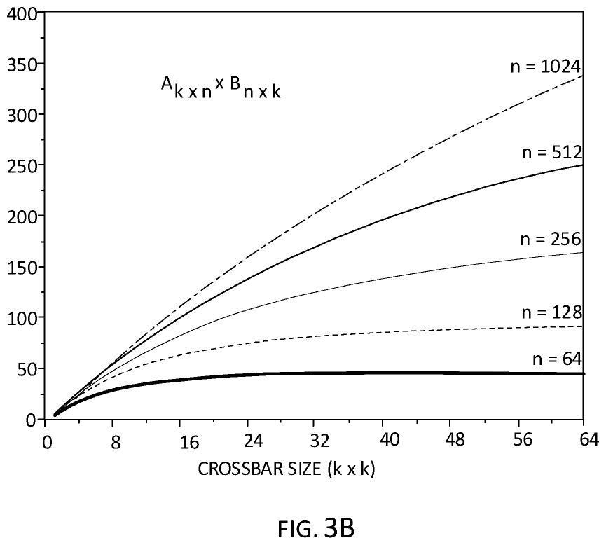

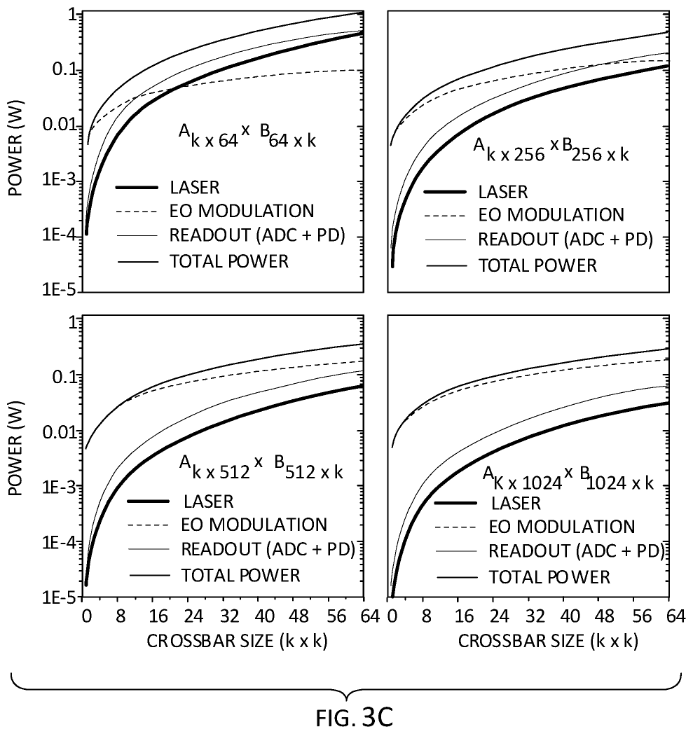

Using the values in Table 4, FIGS. 3A-3C plot the energy consumption of the present coherent matrix-multiplier as a function of photonic crossbar and input matrix dimensions k and n. FIGS. 3A-3C illustrate the influence of matrix and crossbar dimensions on computing efficiency (fₘₒ=12 GHz, N_{b}=5-bits). FIG. 3A illustrates the computational efficiency in energy per multiply-accumulate (MAC) operation as a function of crossbar size and input matrix dimension. FIG. 3B illustrates the computational efficiency in Tera-operations per Watt (TOPS/W) as a function of crossbar size and input matrix dimension. FIGS. 3A and 3B plot the total energy per MAC and overall computational efficiency (in Tera-Ops/W or “TOPS/W”) of the present photonic matrix-matrix multiplier. For n≈k, the computational efficiency can saturate at relatively small crossbar sizes since the laser and electrical readout energies can dominate Equation (22). However, when n>>k, the 1/n term can cause the laser and readout energies to become negligible, and the E/O modulation energy can become dominant. In FIG. 3C, the total power consumption is broken down into the power used by the optical source, E/O modulation, and O/E conversion. The 1/n term in Equation (22) can lead to favorable energy scaling for large matrix operations since both the minimum optical power and relative number of O/E conversions can decrease significantly. FIG. 3C illustrates a breakdown of power consumption as a function of crossbar size for four different matrix dimensions. As the row/column dimension (n) increases, the power of the optical source and readout circuitry decreases, causing the E/O modulation power to dominate.

IV. Comparison with Other Computing Architectures

The present photonic matrix-matrix multiplier according to at least one implementation can be compared against several integrated photonic computing architectures that have been demonstrated experimentally. While these demonstrations have been limited to small weight matrices (e.g., a maximum weight matrix of 4×4 and 9×4 was demonstrated), scaling can be used to project the best-case performance and N_{b}=5-bits. For all fixed-weight architectures, a single photonic core that requires reprogramming if the dimensions of the input matrix A_{m×n} can exceed that of the available photonic weights (m, n>k) can be assumed. Square matrices in the simulations (m=n=p) can be assumed. For the broadcast-and-weight architecture using micro-ring resonators, the number of wavelength channels on a single bus waveguide can be limited to k≤56 based on crosstalk between nearest neighbors.

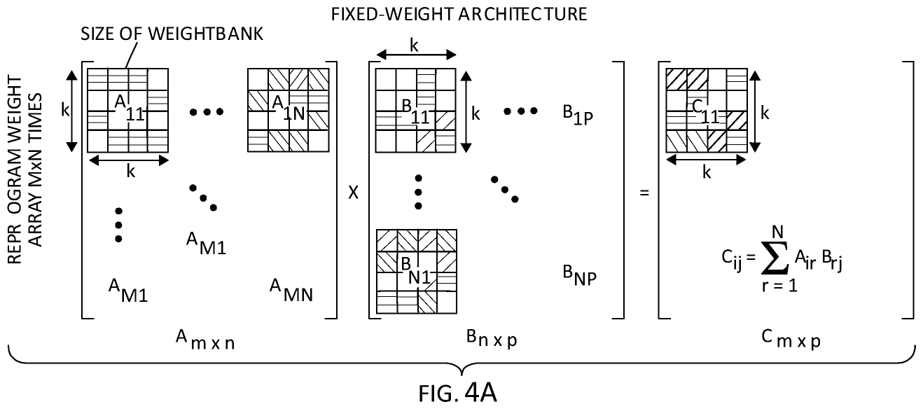

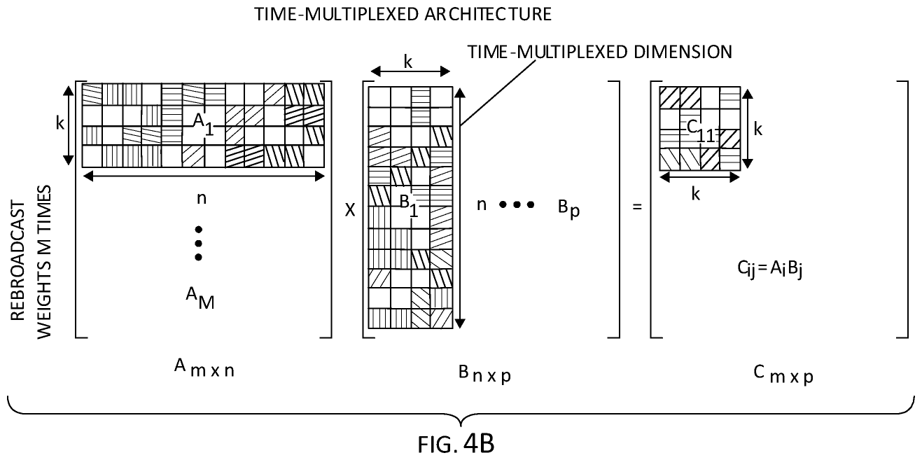

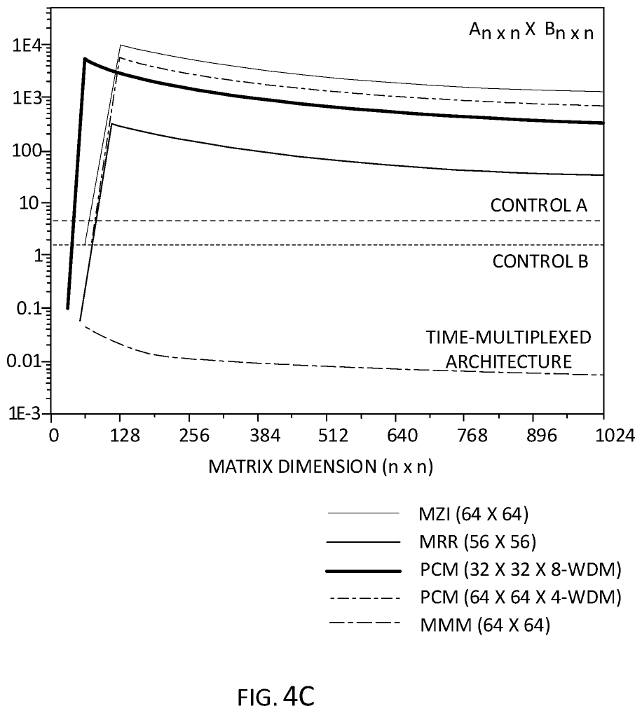

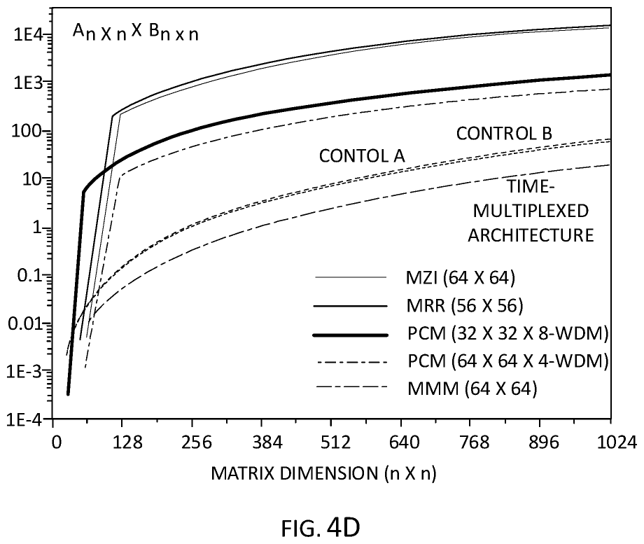

FIGS. 4A-4D illustrate a comparison of fixed-weight versus time-multiplexed architectures for matrix-matrix multiplication. A difference between a fixed-weight photonic architecture and the present time-multiplexed architecture can be highlighted in FIGS. 4A and 4B. FIG. 4A illustrates that for a fixed-weight architecture where m, n>k, the array can be reprogramed a minimum of MN times which can lead to significant latency and energy costs. FIG. 4B illustrates that for the present time-multiplexed architecture, the entire sub-matrix C₁₁ can be computed in n time steps without requiring any reprogramming or additional matrix-matrix operations. In the case when m, n>k (e.g., for practical machine learning tasks with many millions of trained weights), the matrix A_{m×n} can be split into MN sub-matrices of dimension k×k (e.g., An in FIG. 4A). Computing the sub-matrix C₁₁ can require N matrix-matrix MAC operations with N reprogramming steps of the photonic array between. Additionally, the results of each sub-matrix operation can require the O/E conversion and digital storage of (N−1)k² intermediate results which can cause additional latency and energy consumption that can greatly outweigh the advantages of computing in the photonic domain. By contrast, the present time-multiplexed architecture can allow the entire row and column of the input matrix to be processed sequentially with a single readout of the final result (C₁₁). This approach can be much more efficient and may not require any additional O/E conversions or digital storage operations. Additionally, the energy savings can improve with matrix dimension for positive valued inputs.

To estimate the computational efficiency of various fixed-weight photonic platforms, Equation (23) can be used to account for the total energy consumption:

$${E}_{MAC} = \frac{1}{mnp} ( {E}_{l aser} + {E}_{m o d}^{E / O} + {E}_{weights} + {E}_{update} + {E}_{read}^{O / E} + {E}_{mem} + {E}_{digital} ) \qquad ( 23 )$$

where the various computing energies can be defined in Table 1:

TABLE 1

| Equation | Description |
|---|---|
| Eₗₐₛₑᵣ = Nₗₐₛₑᵣ · Pₗₐₛₑᵣ · τₜₒₜₐₗ | Net energy of laser source |
| ${E}_{mod}^{{}_{} E / O} = {N}_{mod} \cdot {β}_{mod} {N}_{b} \cdot n [ \frac{m}{k} ] [ \frac{p}{k} ]$ | Net E/O conversion energy |
| E_{weights} = N_{weights} · P_{quiescent} · τₜₒₜₐₗ | Net energy required to maintain static weights (e.g. thermal-optic heater power) |
| ${E}_{update} = {N}_{weights} \cdot {E}_{program} \cdot ⌈ \frac{m}{k} ⌉ ⌈ \frac{p}{k} ⌉$ | Net energy to update weight array |
| ${E}_{read}^{{}_{} O / E} = ( {N}_{PD} \cdot {E}_{PD} + {N}_{ADC} \cdot {E}_{ADC} ) \cdot ⌈ \frac{m}{k} ⌉ ⌈ \frac{n}{k} ⌉ ⌈ \frac{p}{k} ⌉$ | Net O/E conversion energy |
| ${E}_{mem} = {k}^{{}_{} 2} \cdot {E}_{SRAM} \cdot ⌈ \frac{m}{k} ⌉ ⌈ \frac{p}{k} ⌉ ( ⌈ \frac{n}{k} ⌉ - 1 )$ | Net energy required to store intermediate sub-matrix products in memory |
| ${E}_{digital} = {k}^{{}_{} 2} \cdot {E}_{GPU} \cdot ⌈ \frac{m}{k} ⌉ ⌈ \frac{n}{k} ⌉ ⌈ \frac{p}{k} ⌉$ | Net energy required to perform sub- matrix addition operations digitally |

Table 1 illustrates a description of various parameters used to calculate the energy per MAC operation in FIG. 4C. In the above notation, Nis the number of each component (e.g., lasers, modulators, etc.) specific to each architecture, k×k is the dimension of the sub-matrix product, and m×n and n×p are the dimensions of the two input matrices, A and B.

In the case of the present time-multiplexed architecture according to at least one implementation, there may be no weight components or intermediate sub-matrix products to be stored and/or processed (E_{weights}, E_{update}, Eₘₑₘ, E_{digital}=0). This can significantly reduce the overall energy per MAC by approximately four orders of magnitude compared to the most efficient fixed-weight architecture such as MZI deep learning architecture (MZI), broadcast-and-weight micro-ring resonators (MRR), and in-memory computing architecture with phase-change photonic memory (PCM) as shown in FIG. 4C, which illustrates the energy per MAC. More than approximately 100 times greater computational efficiency can be realized as compared to control commercial GPUs/TPUs (e.g., Control A, Control B) in the limit of large n. The sharp discontinuity in FIG. 4C can be caused by the additional overhead of weight updates and intermediate digital storage and/or computation when the matrix A_{m×n} exceeds the number of available photonic weights. This penalty, which can include the additional overhead of weight updates, can be avoided in the photonic matrix-matrix multiplication (or “MMM”) approach of the present disclosure. The penalty can include the additional overhead of intermediate digital storage and/or computation when the matrix A_{m×n} exceeds the number of available photonic weights.

The dramatic increase in energy consumption for the fixed-weight architectures is at least partially attributable to the need for multiple sub-matrix operations which requires reprogramming of the photonic weight array. In the case of the MZI and MRR architectures, reprogramming a column-addressed array of thermal phase shifters can require a settling time of at least approximately 10 s per column, which can significantly increase the overall energy consumption. While MEMS and electro-optic modulators have been proposed to overcome the static power consumption and slow update speed of thermal phase shifters, these approaches have their own challenges (e.g., optical insertion loss, footprint, leakage current, limited multi-bit resolution, etc.) and have yet to be experimentally confirmed for scalable photonic computing. Electronic switching speeds as fast as approximately 10 ns to approximately 20 ns can be realized for phase-change photonic memory cells, but the switching energy can be on the order of approximately 1 nJ to approximately 10 nJ per switching event.

In the present architecture according to at least one implementation, the energy per weight can be approximately β_{mod}N_{b}/k in the limit of large n and k. Since E/O modulator efficiencies can be on the order of approximately femto-joules per bit, or even less, the cost per weight may be on the order of several femto-joules or less. A fixed-weight architecture that requires frequent weight updates during computation can have inferior performance as compared to implementations according to the present disclosure.

FIG. 4D compares the latency of various computing architectures as a function of matrix dimension. FIG. 4D illustrates latency versus matrix dimension for various photonic architectures (e.g., Control A, Control B, and time-multiplexed architecture) in which f_{mod}=12 GHz and N_{b}=5-bits. The large discontinuity for m, n>k in the MZI, MRR, and PCM architectures can be caused by the slow and power-hungry reprogramming operations of the weight array. Energy per MAC and latency for GPU and TPU architectures can be estimated from reported FLOPS and wall plug power. Similar to the case of computing efficiency, the latency of fixed-weight architectures can increase dramatically once weight updates are considered. In some implementations, the columns are written in parallel, but rows are written sequentially for the MZI, MRR, and PCM architectures. The sharp discontinuity in FIG. 4D can be caused by the additional overhead of weight updates and intermediate digital storage and/or computation when the matrix A_{m×n} exceeds the number of available photonic weights. This penalty can be avoided in the MMM approach of the present disclosure. The penalty can include the additional overhead of weight updates. The penalty can include the additional overhead of intermediate digital storage and/or computation when the matrix A_{m×n} exceeds the number of available photonic weights. Additionally, a digital processing time can be added to account for the N additional sub-matrix accumulate operations. The total processing time can be expressed by Equation (24):

$${τ}_{t otal} = {τ}_{m o d} + {τ}_{update} + {τ}_{digital} \qquad ( 24 )$$

where τ_{mod}, τ_{update}, and τ_{digital} can include the times required for modulation, weight updates, and digital processing of sub-matrix results, respectively. These time delays can be dependent on the specific architecture in question. The total latency can be summarized in Table 2:

TABLE 2

| Photonic | | MVM | MMM Latency (τₜₒₜₐₗ) |
|---|---|---|---|
| Architecture | Scaling Laws | Latency | A_{m×n} × B_{n×p} |
| Coherent MZI | 2k² phase shifters k modulators k photodetectors | 1/f_{mod} | $( \frac{p}{{f}_{mod}} + k \cdot {τ}_{MZI} ) ⌈ \frac{m}{k} ⌉ ⌈ \frac{n}{k} ⌉ + {τ}_{GPU} \cdot mp ⌈ \frac{n}{k} ⌉$ |
| Incoherent Photonic Broadcast- and-Weight | k² microrings k modulators k photodetectors | 1/f_{mod} | $( \frac{p}{{f}_{mod}} + k \cdot {τ}_{Ring} ) ⌈ \frac{m}{k} ⌉ ⌈ \frac{n}{k} ⌉ + {τ}_{GPU} \cdot mp ⌈ \frac{n}{k} ⌉$ |
| Incoherent Photonic Crossbar Array (PCMs) | k² memory cells d · k modulators d · k photodetectors | 1/f_{mod} | $( \frac{p}{d \cdot {f}_{mod}} + k \cdot {τ}_{PCM} ) ⌈ \frac{m}{k} ⌉ ⌈ \frac{n}{k} ⌉ + d \cdot {τ}_{GPU} \cdot mp ⌈ \frac{n}{k} ⌉$ |
| Coherent Photonic Crossbar Array (present architecture) | k × k passive array 2k + 1 modulators 2k² photodetectors | n/f_{mod} | $( \frac{n}{{f}_{mod}} + {τ}_{Read} ) ⌈ \frac{m}{k} ⌉ ⌈ \frac{p}{k} ⌉$ |

Table 2 illustrates a summary of latency equations for four photonic architectures according to the techniques of the present disclosure. While the matrix-vector multiply (MVM) latency can greater for the present time-multiplexed architecture, the total matrix-matrix multiply (MMM) is considerably less for large matrices. τ_{MZI}=τ_{Ring}=10 μs and τ_{PCM}=20 ns can be the latencies associated with thermal-optic phase shifters and phase-change memory cells, respectively. For frequency multiplexed architectures (PCM), d represents the number of wavelength channels used for parallel computation in the same photonic processing core. For the time-multiplexed architecture, column-addressed unit cells reduce the number of ADCs by k which proportionally decreases the readout speed to τ_{Read}=k/f_{mod}.

Unlike typical photonic computing approaches, the architecture of the systems and methods of the present disclosure is highly robust to fabrication variability across the crossbar array. The effect of random variation in the coupling efficiency of one of the row or column directional couplers comprising a unit cell (\tilde{k}ₗ=kᵢ+Δkᵢ, k=kⱼ+Δkⱼ) can be considered. This can be the source of the greatest fabrication error in the present architecture. The non-ideal directional coupler can scale [symbol] iₛ [symbol] by \tilde{k}ₗ\tilde{k}ⱼ which can be factored outside of the integral in Equation (4) and thus can scale the dot-product [symbol] ᵢ· [symbol] ⱼ by a constant. Performing a single Hadamard product between the computed output matrix and a calibrated k×k look-up table can compensate for at least part of the computational burden. Alternatively, the computational burden can be reduced further by adjusting the relative gain of each unit cell's differential amplifier at the hardware level.

By a similar analysis, variations in the fan-out distribution network before the row and column modulators can introduce a scaling term for each unit cell. The most significant impact of fabrication variability in the passive photonic crossbar can be the increase in the total input power of the optical source such that the minimum optical power derived in Equation (16) (or Equation (19) for negative inputs) is satisfied across all unit cells.

### V. Mixed Architectures for Efficient Data Processing

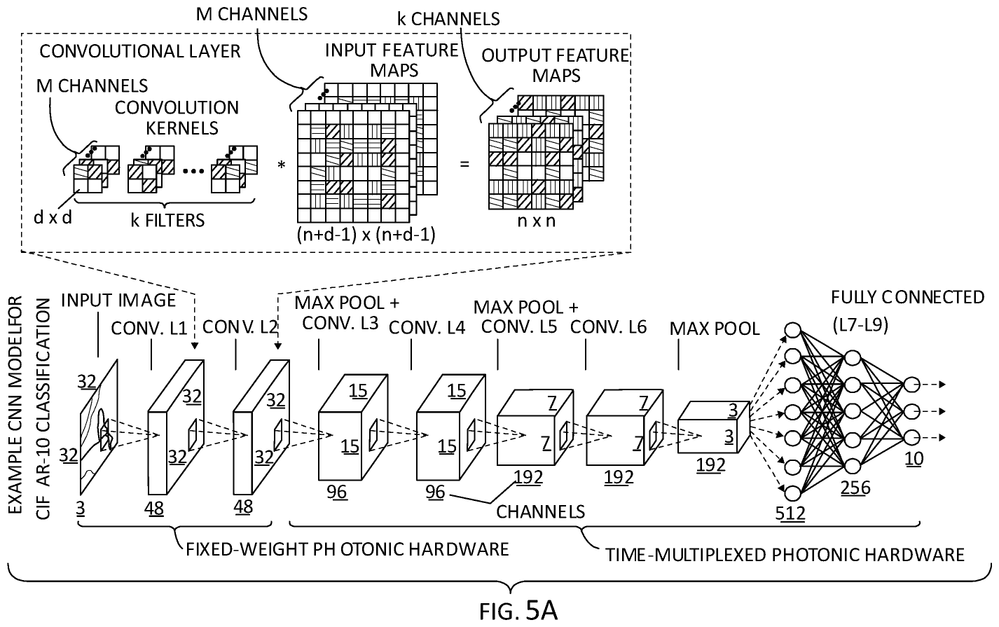

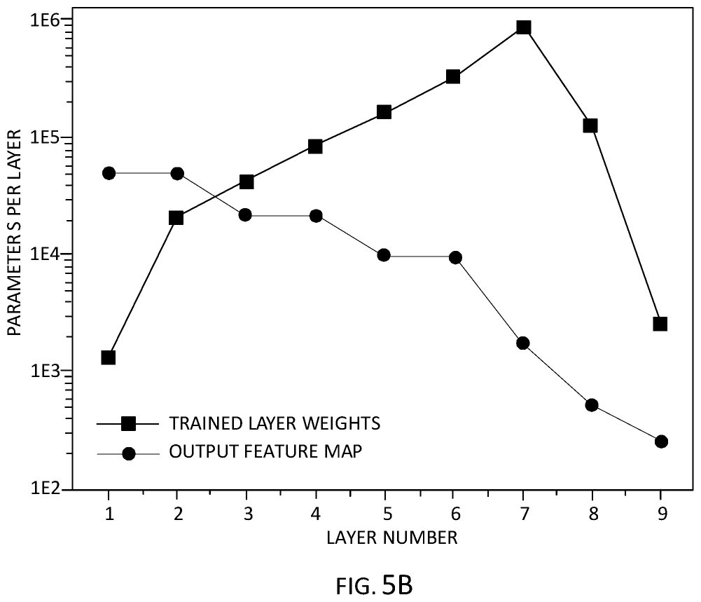

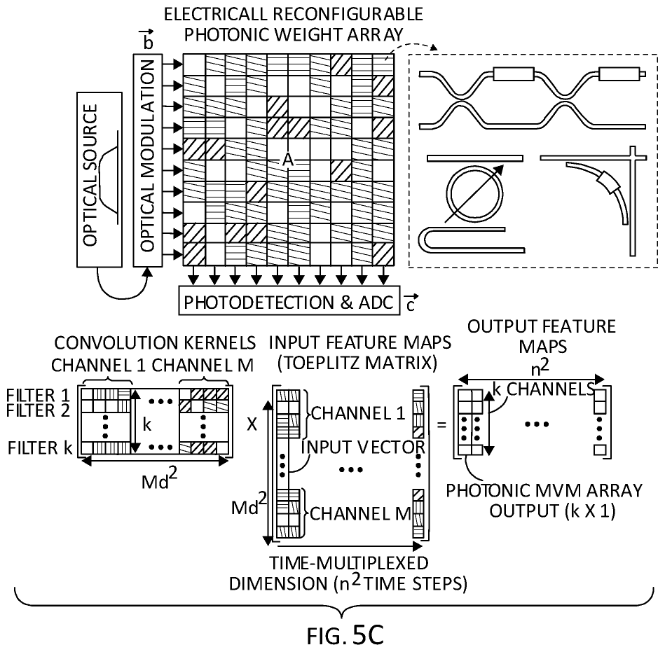

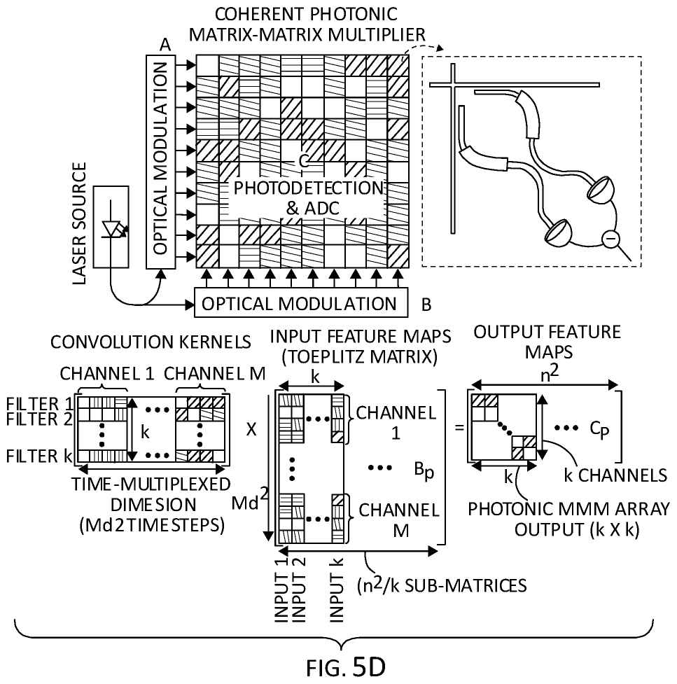

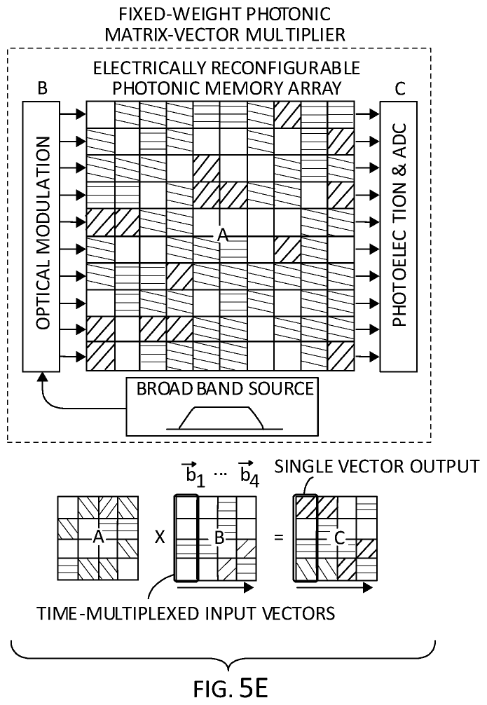

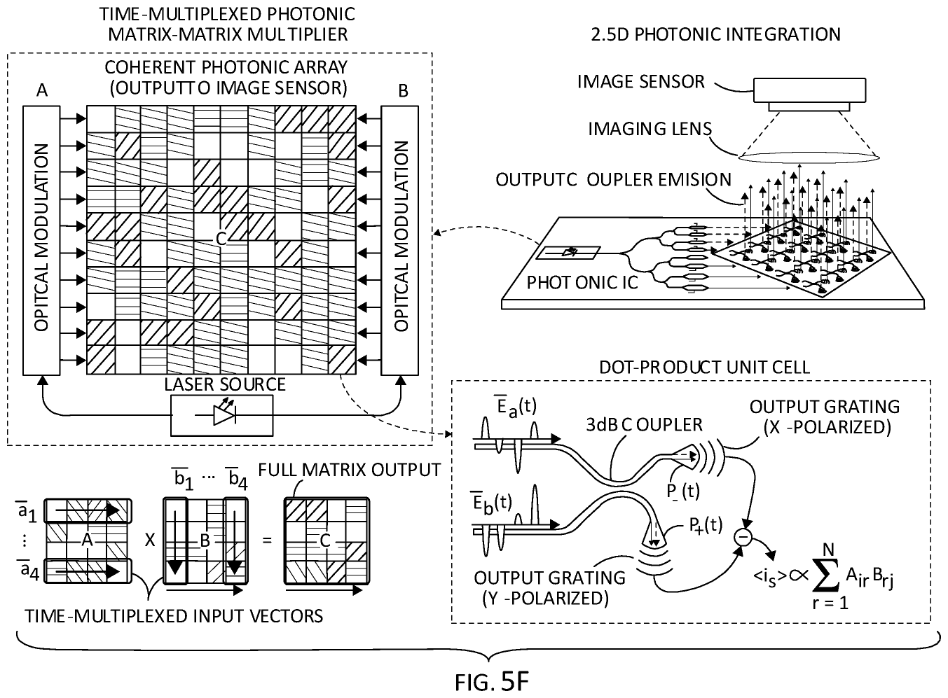

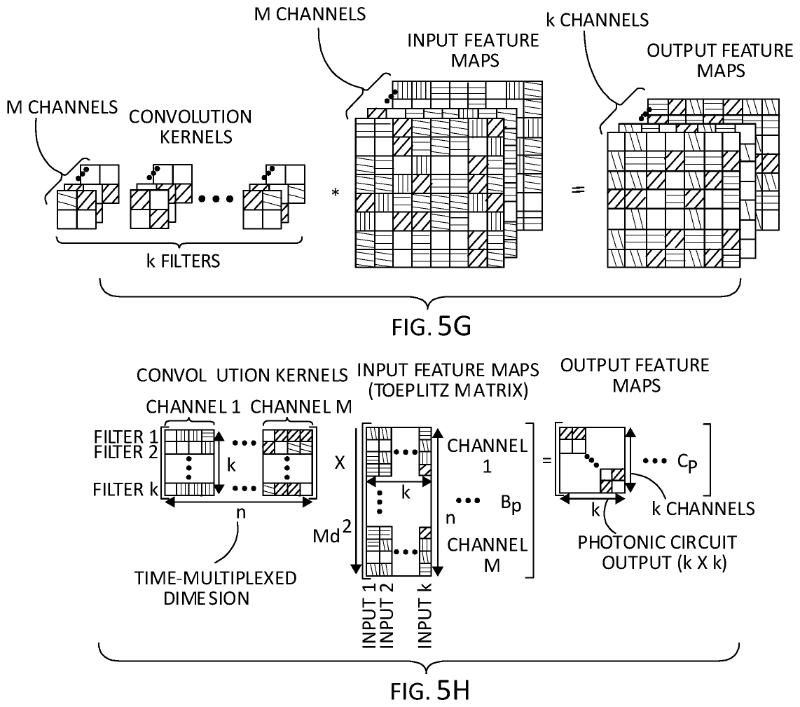

FIGS. 5A-5D illustrate an overview of a mixed-architecture implementation for a convolutional neural network (CNN). FIG. 5A illustrates data flow for a 9-layer CNN used to classify images from the CIFAR-10 dataset. The top inset illustrates input, output, and kernel data dimensions for a convolutional layer. FIG. 5B illustrates a total count of parameters stored and computed for a given layer in the network. FIG. 5C illustrates an architecture overview and convolutional layer implementation for fixed-weight photonic hardware. FIG. 5D illustrates an architecture overview and convolutional layer implementation for time-multiplexed photonic hardware. The fixed-weight approach in FIG. 5C can have lower latency and can be more efficient when the entire convolutional layer can be stored in photonic weights (Md²<<n²). However, as the number of parameters within a layer grows (Md²>>n²), a time-multiplexed approach can scale more efficiently.

A mixed architecture approach of the systems and methods of the present disclosure can combine the relative strengths of fixed-weight and time-multiplexed architectures to achieve efficient photonic computing in large-scale neural networks. This concept can be illustrated through a small, yet practical convolutional neural network (CNN) model used for image classification on the CIFAR-10 dataset shown in FIG. 5A. This CNN model can have 6 convolutional layers and 3 fully connected layers for a total of approximately 1.7 million parameters as detailed in Table 3.

TABLE 3

| Layer | Dimensions | Channels | Activation | Parameters |
|---|---|---|---|---|
| Input CIFAR-10 | 32 × 32 | 3 | — | — |
| Image | | | | |
| Conv L1 | 48 filters (3 × 3) | 3 | ReLU | 1,344 |
| Conv L2 + Max | 48 filters @ 3 × 3 | 48 | ReLU | 20,784 |
| Pool | | | | |
| Conv L3 | 96 filters @ 3 × 3 | 48 | ReLU | 41,568 |
| Conv L4 + Max | 96 filters @ 3 × 3 | 96 | ReLU | 83,040 |
| Pool | | | | |
| Conv L5 | 192 filters @ 3 × 3 | 96 | ReLU | 166,080 |
| Conv L6 + Max | 192 filters @ 3 × 3 | 192 | ReLU | 331,968 |
| Pool | | | | |
| Fully Connected | 1728 × 512 | — | ReLU | 885,248 |
| Fully Connected | 512 × 256 | — | ReLU | 131,328 |
| Fully Connected | 256 × 10 | — | Softmax | 2,570 |
| Total Parameters | | | | 1,663,930 |

Table 3 illustrates a list of layer dimensions and parameters for a sample CNN model designed to classify the CIFAR-10 dataset.

To store the entire model simultaneously in photonic hardware may use more than 400 separate photonic weight banks of size 64×64, corresponding to a total footprint of greater than 10 cm² when assuming a 25×25 μm² unit cell. Rather than storing the entire model in photonic memory or exclusively using a time-multiplexed approach, a fixed-weight photonic computing architecture can be used for the first several (e.g., about 2 to about 6) convolutional layers. This can take advantage of the high speed MVM (matrix vector multiplication) operations that are feasible with a fixed-weight approach when the output feature maps are at their largest, while the number of stored weights is smallest (e.g., Md²<<n² in FIG. 5A). As data flows through the convolutional layers, the number of parameters in each layer may grow, while the output feature maps are reduced in size due to repeated maximum pooling as plotted in FIG. 5B. Thus, the time-multiplexed dimension accommodates the growing number of parameters. Additionally, since the time-multiplexed dimension may exceed the input feature map (Md²>>n²), the sum can be taken along the growing number of channels in the time domain which can minimize the number of opto-electronic conversions. Since a time-multiplexed approach can be used for the layers deeper in the network, the number of costly weight updates in physical hardware can be minimized during training, thus further improving the efficiency of the photonic network.

The implementations disclosed herein are configured to implement a photonic approach to large-scale matrix-matrix multiplication using standard components commonly available at PIC (photonic integrated circuit) foundries. The systems and methods of the present disclosure may significantly reduce the ADC (analog to digital converter) energy consumption and high-speed electronic design requirements of prior photonic matrix-vector multiplier strategies, while addressing the challenge of maintaining both spatial and temporal coherence between optical fields. The challenge can be a major difficulty in free space approaches to photonic computing. Additionally, the systems and methods of the present disclosure can be scalable to large matrix-matrix operations without introducing the additional latency and energy needed to reconfigure fixed photonic weights. The systems and methods of the present disclosure can illustrate that approximately 340 TeraOPs and approximately 5.8 fJ/MAC are feasible using experimentally demonstrated components.

Tables 4A, 4B, 4C, 4D, 4E, and 4F illustrate parameters used to calculate the energy efficiency and latency values plotted in FIG. 3A-3C and FIG. 4A-4D. Component parameters in some implementations are derived from prior experimental results.

Table 4A shows shared component parameters according to at least one exemplary implementation.

TABLE 4A

| | | |
|---|---|---|
| Component | Parameter | Values |

Shared Component Parameters

| | | |
|---|---|---|
| Input Modulators | Frequency | 12 GHz |
| | Energy | 25 fJ/bit |
| | Insertion Loss | 8.5 dB |
| Photodetectors | Capacitance | 35 fF |
| | Responsivity | 0.8 A/W |
| | Bias voltage | 1 V |
| | Energy | 0.14 pJ |
| Readout ADC | Resolution | 6-bit |
| | Frequency | 12 GSPS |
| | Energy | 1.08 pJ/sample |
| SRAM cell | Read/Write Speed | Not considered |
| | Energy | 1 pJ/bit |
| GPU | Compute Performance | 14 TeraOP/s |
| | Chip Power | 250 W |

Table 4B shows coherent MZI deep learning architecture parameters according to at least one implementation.

TABLE 4B

| | | |
|---|---|---|
| Component | Parameter | Values |

Coherent MZI Deep Learning Architecture

| | | |
|---|---|---|
| MZI Array | Matrix Size | 64 × 64 |
| | Precision | 5 bit |
| Laser | Wavelength | 1550 nm |
| | Efficiency | 20% |
| | Count | 1 |
| Input Modulators | Count | 64 |
| MZI matrix | Weight Update | 0.1 MHz |
| (thermo-optic weights) | Quiescent Energy | 10 mW/heater |
| | Insertion Loss | 0.03 dB |
| | Count | 2 × 64 × 64 |
| Photodetectors | Count | 64 |
| Readout ADC | Count | 64 |

Table 4C shows micro-ring resonator architecture parameters according to at least one implementation.

TABLE 4C

| | | |
|---|---|---|
| Component | Parameter | Values |

Micro-ring Resonator Architecture (Broadcast & Weight)

| | | |
|---|---|---|
| Micro-ring Array | Matrix Size | 56 × 56 |
| | Precision | 5 bit |
| Laser | Wavelength | 1550 ± 25 nm |
| | Efficiency | 20% |
| | Count | 56 |
| Input Modulators | Count | 56 |
| Micro-ring matrix | Weight Update | 0.1 MHz |
| (thermo-optic weights) | Quiescent Energy | 0.6 mW/ring |
| | Insertion Loss | 3 dB |
| | Count | 56 × 56 |
| Photodetectors | Count | 56 |
| Readout ADC | Count | 56 |

Table 4D shows medium photonic tensor core parameters according to at least one exemplary implementation.

TABLE 4D

| | | |
|---|---|---|
| Component | Parameter | Values |

Medium Photonic Tensor Core (Phase-Change Crossbar Array)

| | | |
|---|---|---|
| PCM Array | Matrix Size | 32 × 32 |
| (32 × 32, 8-WDM) | Wavelength Channels | 8 |
| | Precision | 5 bit |
| Laser | Wavelength | 1550 ± 50 nm |
| | Efficiency | 20% |
| | Count | 32 × 8 |
| Input Modulators | Count | 32 × 8 |
| PCM matrix | Weight Update | 20 MHz |
| | Update Energy | 10 nJ |
| | Quiescent Energy | N/A |
| | Insertion Loss | 20 dB |
| | Count | 32 × 32 |
| Photodetectors | Count | 32 × 8 |
| Readout ADC | Count | 32 × 8 |

Table 4E shows large photonic tensor core parameters according to at least one exemplary implementation.

TABLE 4E

| | | |
|---|---|---|
| Component | Parameter | Values |

Large Photonic Tensor Core (Phase-Change Crossbar Array)

| | | |
|---|---|---|
| PCM Array | Matrix Size | 64 × 64 |
| (64 × 64, 4-WDM) | Wavelength Channels | 4 |
| | Precision | 5 bit |
| Laser | Wavelength | 1550 ± 50 nm |
| | Efficiency | 20% |
| | Count | 64 × 4 |
| Input Modulators | Count | 64 × 4 |
| PCM matrix | Weight Update | 20 MHz |
| | Update Energy | 10 nJ |
| | Quiescent Energy | N/A |
| | Insertion Loss | 28.1 dB |
| | Count | 64 × 64 |
| Photodetectors | Count | 64 × 4 |
| Readout ADC | Count | 64 × 4 |

Table 4F shows time-multiplexed photonic matrix-matrix multiplier parameters according to at least one exemplary implementation.

TABLE 4F

| | | |
|---|---|---|
| Component | Parameter | Values |

Time-multiplexed Photonic Matrix-Matrix Multiplier

| | | |
|---|---|---|
| MMM Crossbar | Matrix Size | 64 × 64 |
| | Precision | 5 bit |
| Laser | Wavelength | 1550 nm |
| | Efficiency | 20% |
| | Count | 1 |
| Input Modulators | Count | 2 × 64 + 1 |
| Crossbar Array | Weight Update | N/A |
| | Update Energy | N/A |
| | Quiescent Energy | N/A |
| | Insertion Loss | 4.66 dB |
| | Count | 64 × 64 |
| Photodetectors | Count | 2 × 64 × 64 |
| Readout ADC | Count | 64 (row addressed) |

FIG. 5E illustrates a fixed-weight photonic matrix-vector multiplier according to an example implementation. Fixed-weight photonic approaches can be limited by the size of the memory array and can require a broadband light source.

FIG. 5F illustrates a time-multiplexed photonic matrix-vector multiplier according to an example implementation. Matrices A and B can be encoded in the optical field. Each unit cell can contain a photoelectric multiplier to achieve the dot product between two time-multiplexed optical signals. Light can be coupled out-of-plane to an image sensor using grating couplers to take full advantage of both 2D and 3D integration.

In at least one implementation, a coherent photonic integrated circuit can be designed and fabricated. A small-scale photonic circuit which is capable of performing matrix-matrix multiplication between two 4×4 matrices can be fabricated. Thermo-optic modulators can be used initially to encode the input row and column vectors of the two matrices. These modulators can be controlled by a multichannel current source to generate arbitrary amplitude and phase modulation needed to encode input data.

For an integrated photonic circuit which accomplishes both fan-out and interference, uniform power distribution throughout the circuit can be ensured even in the presence of non-ideal components in at least one implementation. In the present photonic matrix-matrix multiplier, the optical power required for fan-out can scale as k rather than k². Non-idealities can be addressed through a scaling factor.

FIG. 5G illustrates a schematic of a 3D convolutional layer according to an example implementation. FIG. 5H illustrates a schematic of a time-multiplied matrix according to an example implementation. Hardware-tailored deep learning models can be designed for the accelerator. An open-source compiler can adapt the dimensions of hidden layers within fully connected DNNs and convolutional neural networks (CNNs) to minimize inference latency and energy consumption when implemented on the hardware. One convolutional layer of a CNN shown in FIG. 5G can be mapped to a large-scale matrix-matrix multiplication shown in FIG. 5H. For maximum efficiency, the number of filters can be kq, where q is an integer and k×k is the number of dot-product unit cells. The number of filters in a convolutional layer can be modified. Different methods (e.g., reducing the number of filters in a given layer while increasing the size of each filter) may be utilized to achieve comparable test accuracy and training time as the original model. This compiler can be written in Python and can be compatible with the PyTorch machine learning library to allow GPU training of the deep learning models that have been refined by the compiler. Custom functions for the PyTorch library can be developed to model DNN inference and training in analog photonic hardware. These functions can include added noise (e.g., shot noise, dark current, readout noise, etc.) and fixed precision arithmetic. The overall inference accuracy of the hardware-tailored deep learning models of at least one implementation is subject to the effects of tailored layer dimensions, added noise, and fixed precision arithmetic.

The estimated computational efficiency and inference latency of standard DNN and CNN models which have been chosen for the photonic hardware of the present disclosure can be benchmarked. During the compiling stage, the total latency and energy required by the photonic accelerator at each layer in the network can be estimated. This can include total optical power, electro-optic modulator energy consumption, ADC readout energy, READ/WRITE energy of digital memory, and any additional digital operations required to apply the calibration matrix M_{cal}. The total latency and energy usage of the hardware of the present disclosure can be compared with the benchmarked performance of control accelerators. The image classification and object detection models can be used to allow a comparison with control digital hardware. Further, the techniques described herein can be employed in connection with methods for enhancing hardware parallelization to maximize inference throughput for various deep learning models (e.g., multiple photonic matrix-multiplier circuits per image sensor) and methods to accelerate the training of DNNs using the photonic platform (e.g., training with mixed-precision or direct feedback alignment using large-scale photonic matrix-matrix multiplication).

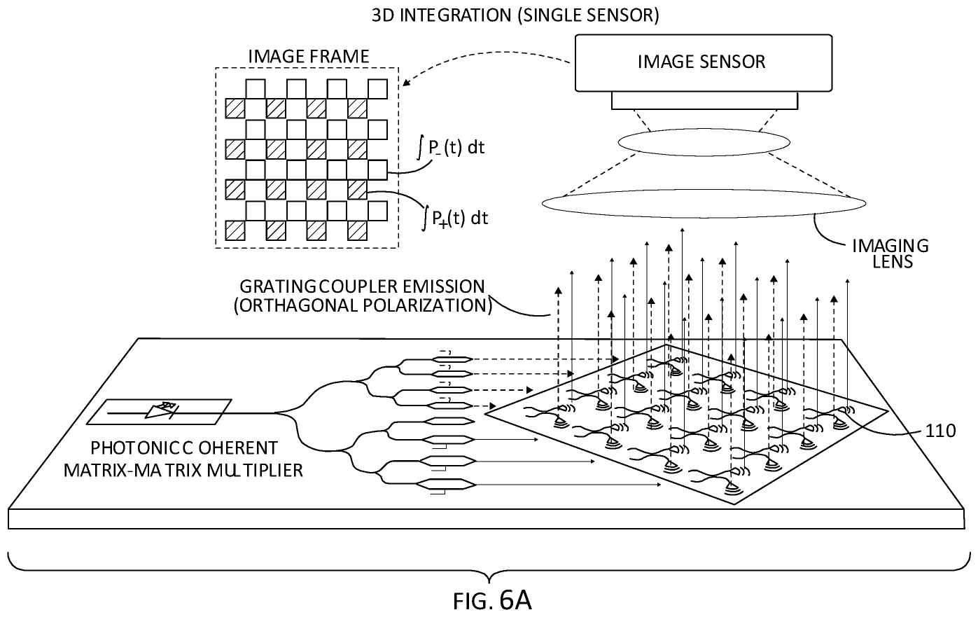

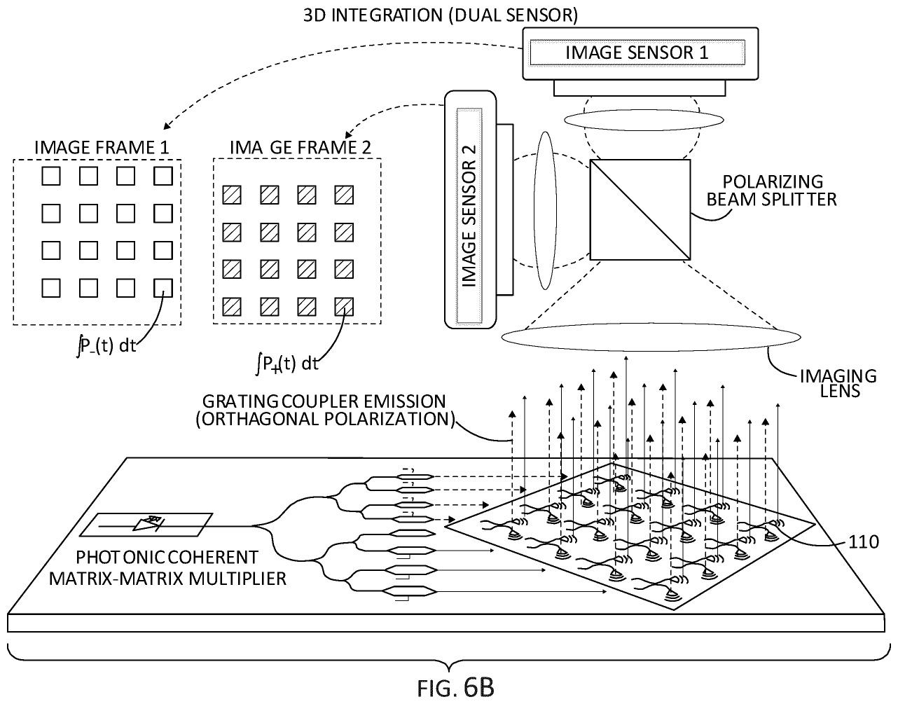

FIG. 6A illustrates a 3D integration of an image sensor (e.g., CMOS image sensor) and photonic matrix-matrix multiplier according to at least one implementation. The present photonic circuit is configured to be combined with a short wave infra-red (SWIR) image sensor (e.g., an IMX991 CMOS sensor made by SONY Corporation of Tokyo, Japan) to perform large-scale photoelectric readout and ADC conversion. The image sensor is configured to have a high-speed framerate of 250 fps at 8-bit resolution (approximately 10⁶ fps is achievable in ultrahigh-speed cameras), a global shutter which allows accurate integration timing across the sensor array, pixels with high quantum efficiency (η>0.9) at λ=1550 nm, and low dark current which can allow for lower optical powers and longer integration times. The outputs (e.g., grating coupler outputs) of each dot-product unit cell can be focused through an objective lens onto the image sensor as shown in FIG. 6A. Using an out-of-plane, free-space optical path to the image sensor (e.g., 3D integration) may simplify the connectivity between the output of the dot-product unit cells and the photodetectors and ADC converters. Additionally, the photonic and opto-electronic readout circuitry is configured to be distributed among separate chips (e.g., substrates, electronic packages, etc.) in some implementations, allowing distinct fabrication processes to be used for maximum yield.

FIG. 6B illustrates a 3D integration using a polarizing beam splitter and dual image sensor (e.g., image sensor 1 and image sensor 2) for improved throughput according to at least one implementation. The dual image sensor (e.g., dual CMOS image sensor) is configured to spatially encode both balanced photodetector signals (∫P₊dt and ∫P₋dt) on a single image which can be further processed in software to extract the difference signal [symbol] iₛ [symbol] . The photodetector signal ∫P₋dt can include the first output 130 of the optical signal. The photodetector signal ∫P₊dt can include the second output 135 of the optical signal. This operation may be simplified by using a polarizing beam splitter after the objective to separate the signals P₊ and P₋ into two separate image frames which can then be subtracted in software (illustrated in FIG. 6B). Alternatively, since the grating couplers can be configured to emit orthogonally polarized light, a single image sensor with polarization sensitive pixels and in-hardware balanced detection can be used to perform the difference measurement in the sensor array itself. A free-space optical setup may be used in some implementations with an objective lens. By matching the pixel pitch to the dimensions of the dot-product unit cell, the entire photonic circuit/image sensor system is configured to be combined in a single compact multi-chip package.

In at least one implementation, coherent matrix-matrix multiplication is carried out. Matrix-matrix multiplication can be performed using the photonic integrated circuit and image sensor according to at least one implementation. The emission efficiency of each dot-product unit cell output coupler and collection efficiency of the corresponding image sensor pixel(s) can be calibrated. The result can provide a calibration matrix M_{cal} which can be multiplied elementwise to the measured output matrices P⁺ and P₋. Thus, to calculate the matrix product A×B=C, (P₊−P₋)∘M_{cal}=Ĉ can be performed in software. This can reduce the digital computational complexity of matrix multiplication from approximately O(mnp) to approximately O(mp) for two matrices of size m×n and n×p, which can be a significant advantage for n>>m, p. Implementations can perform (P₊−P₋)∘M_{cal} in hardware by controlling the amplification of each differential pixel pair to account for the calibration matrix M_{cal}. To experimentally determine the computational precision of the approach, the mean square error between the exact result and the measured output, MSE=ΣΣ(Cᵢⱼ−Ĉᵢⱼ)²/k² can be measured, where the photonic circuit has k×k unit cells.

A large-scale design (matrix size of 16×16) can be fabricated at a photonic foundry which implements high-speed electro-optic silicon modulators on-chip. Post-processing methods of laser-trimming can be evaluated to select an appropriate the fixed phase difference Δφ′.

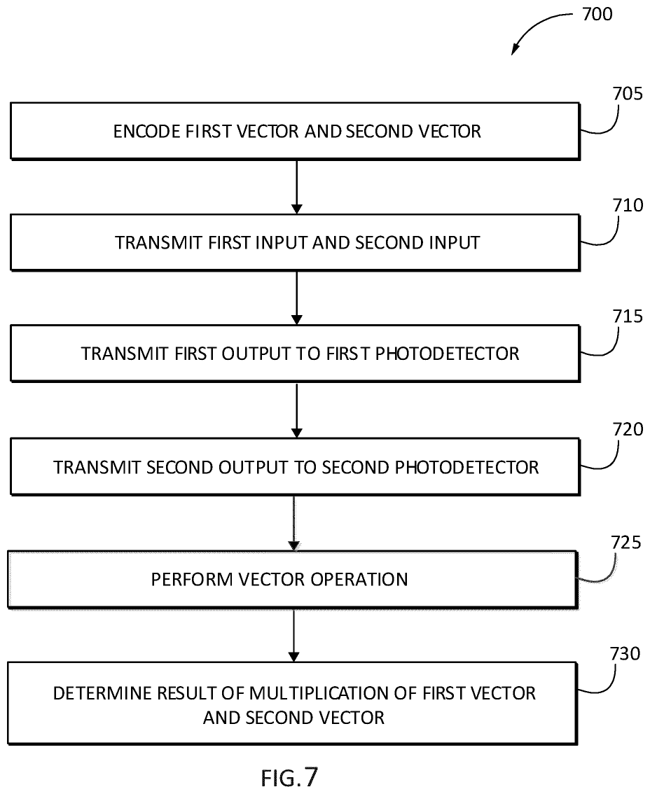

FIG. 7 illustrates a method 700 of performing vector operations according to at least one implementation. In brief, the method 700 includes encoding a first vector and a second vector (BLOCK 705). In some implementations, the method 700 includes transmitting a first input and a second input (BLOCK 710). In some implementations, the method 700 includes transmitting a first output to a first photodetector (BLOCK 715). In some implementations, the method 700 includes transmitting a second output to a second photodetector (BLOCK 720). In some implementations, the method 700 includes performing the at least one vector operation (BLOCK 725). In some implementations, the method 700 includes determining a result of the multiplication of the first vector and the second vector (BLOCK 730).

Further, in some implementations, the method 700 includes encoding a first vector and a second vector (BLOCK 705). The method 700 includes encoding, by a controller, a first vector in time-varying amplitudes of a first electric field. The method 700 includes encoding, by the controller, a second vector in time-varying amplitudes of a second electric field.

The method 700 includes transmitting a first input and a second input (BLOCK 710). The method 700 includes transmitting, by the controller, a first input of an optical signal to a beam splitter. The method 700 includes transmitting, by the controller, a second input of the optical signal to the beam splitter. The method 700 includes transmitting, by the controller, the first input and the second input of the optical signal to the beam splitter to generate a first output of the optical signal and a second output of the optical signal. The first input and the second input can be temporally and spatially coherent.

In some implementations, the method 700 include transmitting the first output to a first photodetector (BLOCK 715). The method 700 includes transmitting, by the controller, the first output of the optical signal to the first photodetector to generate a third output of the optical signal.

In some implementations, the method 700 includes transmitting a second output to a second photodetector (BLOCK 720). The method 700 includes transmitting, by the controller, the second output of the optical signal to the second photodetector to generate a fourth output of the optical signal. A unit cell output can include the third output of the optical signal and the fourth output of the optical signal.

In some implementations, the method 700 includes performing the at least one vector operation (BLOCK 725). The method 700 includes performing the at least one vector operation by multiplying the first vector and the second vector based on the unit cell output from one or more of a plurality of unit cells.

In some implementations, the method 700 includes determining a result of the multiplication of the first vector and the second vector (BLOCK 730). The method 700 includes determining, by the controller, the result of multiplication of the first vector and the second vector based on the unit cell output from one or more of a plurality of unit cells.

In some implementations, the method 700 includes determining, by the controller, a difference between the third output of the optical signal and the fourth output of the optical signal. In some implementations, the method 700 includes time-multiplexing, by the controller, the first vector and the second vector. In some implementations, the optical signal encodes matrix elements of at least one of a tensor, a matrix, or a vector. The method 700 includes scaling, by the controller, the matrix elements of at the least one of the matrix or the vector to a value in a range of [−1, 1].

In some implementations, the method 700 includes performing, by the controller, real matrix multiplication by controlling phases of the optical signal and amplitudes of the optical signal. In some implementations, the method 700 includes performing, by the controller, complex matrix multiplication by controlling phases of the optical signal and amplitudes of the optical signal. In some implementations, the method 700 includes measuring, by the controller, optical intensity on a substrate. In some implementations, the method 700 includes transmitting, by a light source, the optical signal.

In some implementations, the method 700 includes receiving, by one or more of a plurality of modulators, the optical signal from a light source. In some implementations, the method 700 includes modulating, by the one or more of the modulators, amplitudes of the optical signal. In some implementations, the method 700 includes modulating, by the one or more of the modulators, phases of the optical signal. In some implementations, the method 700 includes transmitting, by the one or more of the modulators, the modulated amplitudes of the optical signal and modulated phases of the optical signal to the beam splitter.

In some implementations, the method 700 can include transmitting, by the controller, the optical signal through fixed-weight photonic hardware. In some implementations, the method 700 includes disposing the beam splitter on a substrate (e.g., a chip, microchip, electronic package, board, etc.). In some implementations, the method 700 includes disposing the first photodetector and the second photodetector in free space.

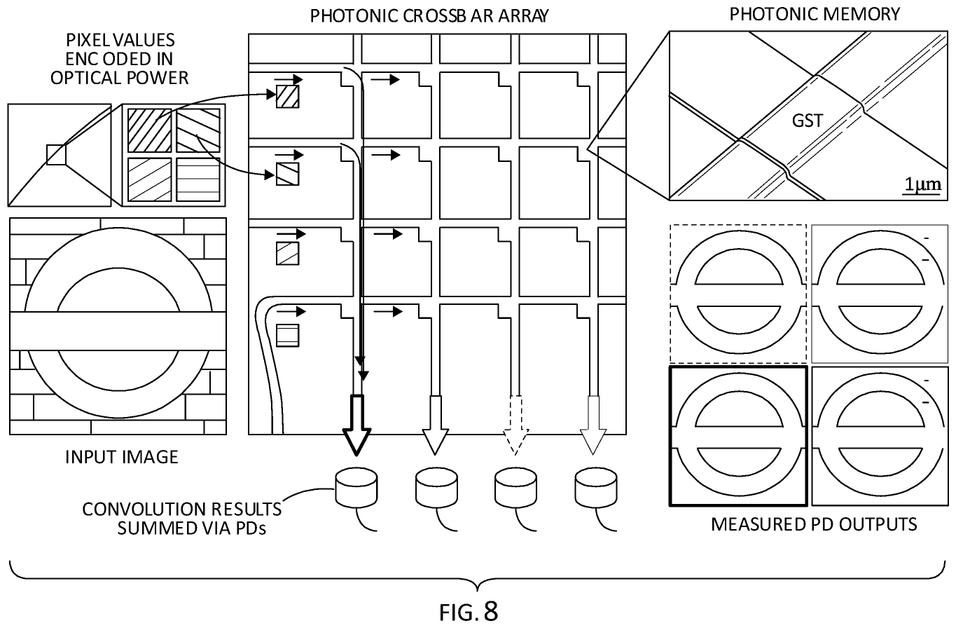

FIG. 8 illustrates all-optical convolutions according to an example implementation. The all-optical convolutions can be carried out in at least one implementation with four 2×2 edge detection kernels using a 4×4 phase change photonic memory array (one kernel encoded per column via photonic memory cells.

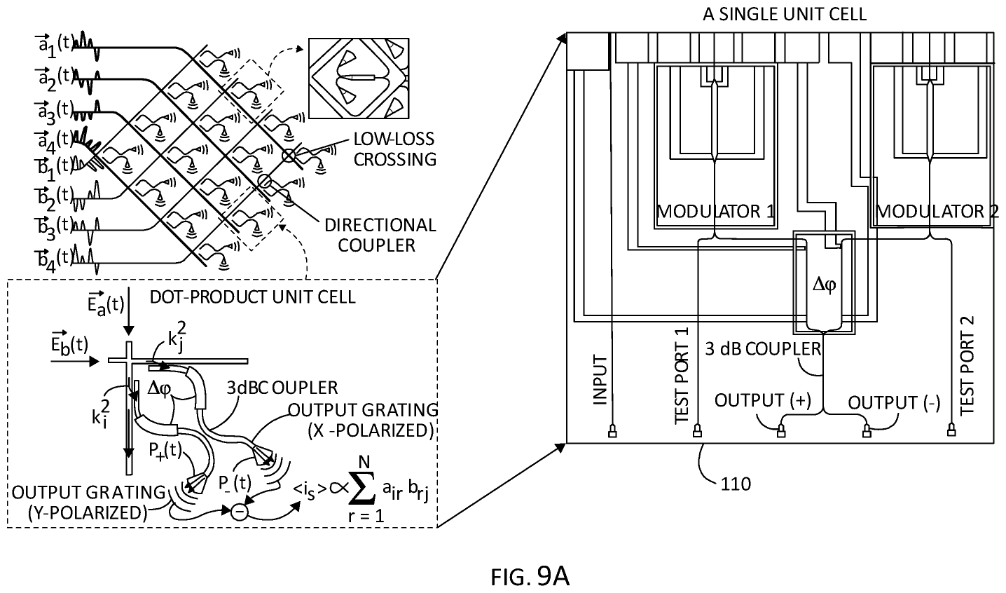

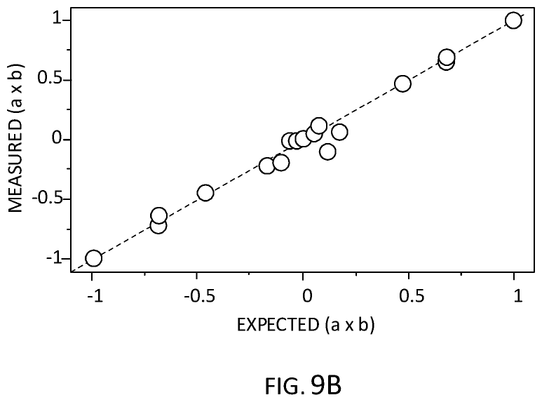

FIG. 9A illustrates a photonic dot-product prototype according to an example implementation. The prototype of the unit cell 110 can give the same functionality as the coherent crossbar array. The prototype can allow for experimental testing of a single unit cell 110.

FIG. 9B illustrates a plot of measured a×b vs expected a×b according to an example implementation. The multiplication can be achieved using the prototype (e.g., dot-product prototype) of FIG. 9A. The multiplication can be measured between two numbers for a×b where a, b∈[−1, +1].

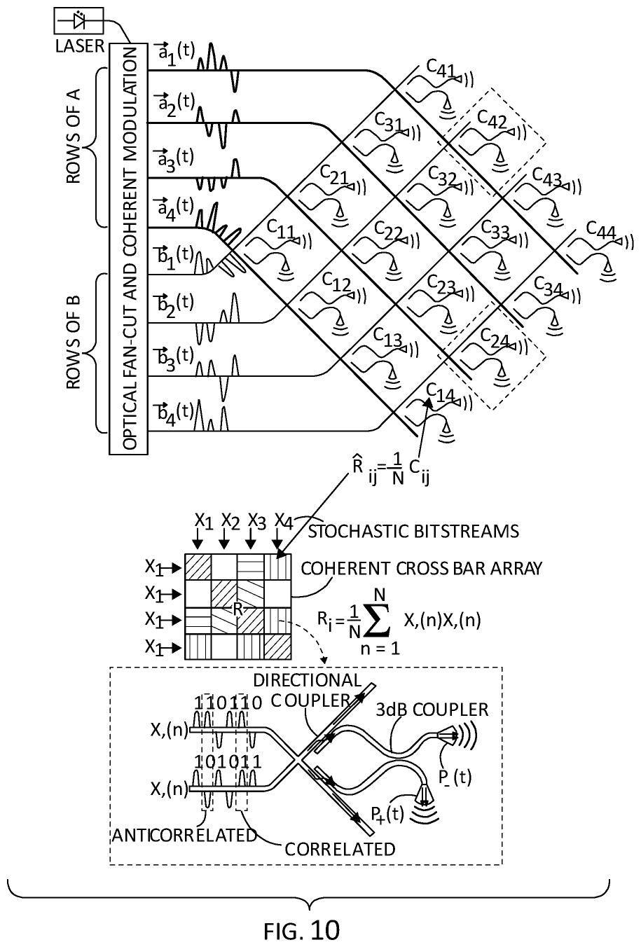

FIG. 10 illustrates a schematic of temporal correlation using a coherent crossbar array according to an example implementation. Temporal correlations in stochastic bit streams and analog signals can be detected. Real-time measurement of statistical correlations between event-based data streams can be crucial for a variety of fields such as Internet of Things (IoT), networking, healthcare, and social sciences. For example, in the case of IoT and networking, correlation detection can be used to quickly alert system administrators of an adversarial attack from network traffic patterns or of a potential systems failure from anomalous events in IoT sensors. Quickly identifying correlations on dynamic data streams with low latency and high efficiency can be advantageous, especially for data already in the optical domain. Coherent photonic crossbar arrays can be used to measure the correlation matrix between multiple event-based optical bit streams in parallel. The correlation between two discrete-time, stochastic bit streams can be estimated using the uncentered covariance matrix defined as Equation (25):

$${\hat{R}}_{i j} = \frac{1}{N} {\sum }_{n = 1}^{N} {X}_{i} ( n ) {X}_{j} ( n ) \qquad ( 25 )$$

where Xᵢ(n) and Xⱼ(n) are the stochastic bit streams, n is the discrete time step, and N is the total number of samples. If Xᵢ(n) and Xⱼ(n) have a mean value of zero (e.g., an equal chance of a binary “0” or “1” in this case), then the ij^{th} element of the correlation matrix is equal to \hat{R}ᵢⱼ/\sqrt{\hat{R}ᵢᵢ\hat{R}ⱼⱼ}. Since \hat{R}ᵢⱼ is the discrete dot-product between Xᵢ and Xⱼ, each dot-product unit cell in the time-multiplexed architecture can output a value directly proportional to the correlation matrix. Thus, the entire correlation matrix between multiple bit streams can be estimated in real-time. This task can be particularly well suited to the time-multiplexed photonic crossbar architecture for applications requiring temporal correlation detection since the data is already serialized in the time domain.

\hat{R}ᵢⱼ can be calculated by holding the amplitude of all modulators at a constant value and encoding stochastic bit streams in the phase of the optical signal (logical “0”→φ=0 and logical “1”→φ=π). The resulting product between Xᵢ(n)Xⱼ(n) at each time step n can thus yield either a +1 if the bits are correlated and −1 if the bits are uncorrelated since Δφ=0 and ±π, respectively. This encoding can ensure a mean value of zero provided “0” and “1” are equally probable. Summation and electronic readout of the covariance matrix \hat{R} can be performed on the balanced homodyne detector. Element-wise scaling of \hat{R} can then be performed in post-processing to calculate the correlation matrix using the total number of bits (N) and the values measured along the diagonal \hat{R}ᵢᵢ.

The amplitude and phase can be used to find the temporal correlation between multiple analog channels and a target waveform. This approach can encode real numbers between [−1, +1] rather than simply −1 or +1. N different analog signals can be input along the columns of the N×N crossbar array while a target waveform with N different time delays can be sent along the rows. Signals that match the target in amplitude and phase can result in a high correlation signal detected by the dot-product unit cell. Such techniques have multiple potential applications in the optical domain, such as header recognition in optical routing or identifying reflected LIDAR signals.

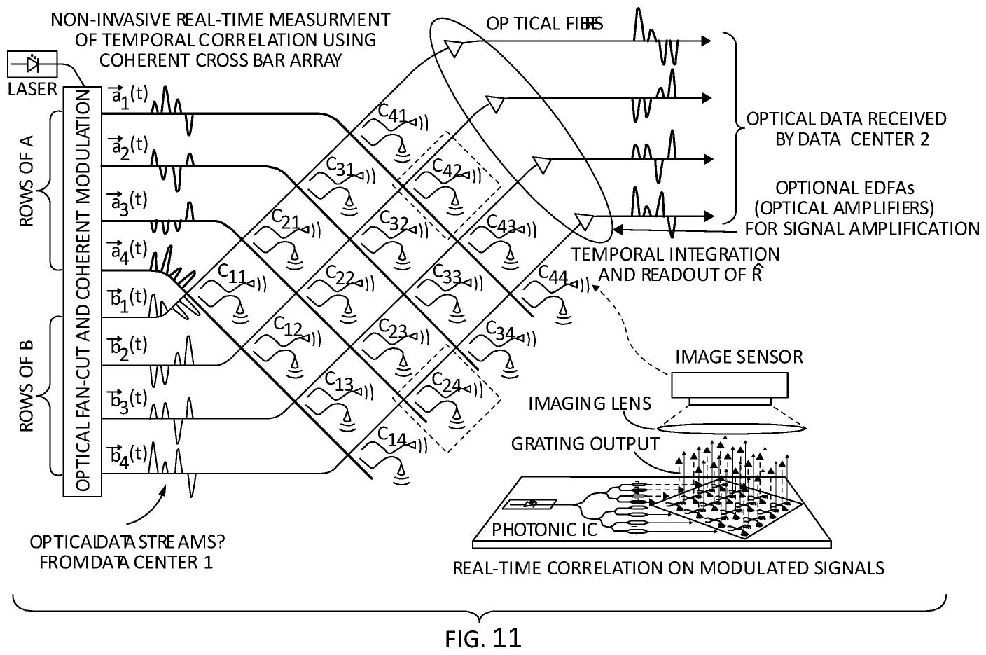

FIG. 11 illustrates a schematic of temporal correlation using a coherent crossbar array according to an example implementation. The platform can be used in a non-invasive way to measure the temporal correlation of optical signals sent from a datacenter in real time. This can include coupling a portion of the light to the crossbar array. The modulated optical signals can be split before or after the crossbar array. As the optical correlation can be integrated over time, the relative strength of the correlation can become larger with a greater sample number (N).

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources. The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, microprocessors, and any one or more processors of a digital computer. A processor can receive instructions and data from a read only memory or a random access memory or both. The elements of a computer are a processor for performing actions in accordance with instructions and one or more memory devices for storing instructions and data. A computer can include, or be operatively coupled to receive data from or transfer data to, or both, one or more mass storage devices for storing data, e.g., magnetic, magneto optical disks, or optical disks. A computer need not have such devices. Moreover, a computer can be embedded in another device, e.g., a personal digital assistant (PDA), a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The implementations described herein can be implemented in any of numerous ways including, for example, using hardware, software or a combination thereof. When implemented in software, the software code can be executed on any suitable processor or collection of processors, whether provided in a single computer or distributed among multiple computers.

Further, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to or receive communications from other devices. The display unit(s) may be provided, for example, to allow a user to view various information in connection with execution of the instructions. The user input device(s) may be provided, for example, to allow the user to make manual adjustments, make selections, enter data or various other information, or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages or programming or scripting tools, and also may be compiled as executable machine language code or intermediate code that is executed on a framework or virtual machine.

The systems and methods described herein may be embodied in other specific forms without departing from the characteristics thereof. The foregoing implementations are illustrative rather than limiting of the described systems and methods.

All of the publications, patent applications and patents cited in this specification are incorporated herein by reference in their entirety.

### VI. Definitions

Technical and scientific terms used herein have the meanings commonly understood by one of ordinary skill in the art, unless otherwise defined. Any suitable materials and/or methodologies known to those of ordinary skill in the art can be utilized in carrying out the methods described herein.

The following definitions are provided to facilitate understanding of certain terms used throughout this specification.

The terms “program” or “software” are used herein to refer to any type of computer code or set of computer-executable instructions that can be employed to program a computer or other processor to implement various aspects of implementations as discussed above. One or more computer programs that when executed perform methods of the present solution need not reside on a single computer or processor, but may be distributed in a modular fashion amongst a number of different computers or processors to implement various aspects of the present solution.

Computer-executable instructions may be in many forms, such as program modules, executed by one or more computers or other devices. Program modules can include routines, programs, objects, components, data structures, or other components that perform particular tasks or implement particular abstract data types. The functionality of the program modules can be combined or distributed as desired in various implementations.

Furthermore, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

As used in the description of the invention and the appended claims, the singular forms “a”, “an”, and “the” are used interchangeably and intended to include the plural forms as well and fall within each meaning, unless the context clearly indicates otherwise. Also, as used herein, “and/or” refers to, and encompasses, any and all possible combinations of one or more of the listed items, as well as the lack of combinations when interpreted in the alternative (“or”).

As used herein, the term “comprising” or “comprises” is intended to mean that the devices and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Implementations defined by each of these transition terms are within the scope of this invention. When an implementation or embodiment is defined by one of these terms (e.g., “comprising”), it should be understood that this disclosure also includes alternative implementations, such as “consisting essentially of” and “consisting of.”

“Substantially” or “essentially” means nearly totally or completely, for instance, 95%, 96%, 97%, 98%, 99%, or greater of some given quantity.

The term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term. For example, in some implementations, it will mean plus or minus 5% of the particular term. Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the disclosure.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. The scope of the systems and methods described herein is thus indicated by the appended claims, rather than the foregoing description, and changes that come within the meaning and range of equivalency of the claims are embraced therein.

What is claimed is:

1. A device for performing at least one vector operation, comprising:
(a) a photonic crossbar array comprising a plurality of unit cells, wherein one or more of the plurality of unit cells comprises:
(i) a beam splitter configured to:
receive (i) a first input of an optical signal and (ii) a second input of the optical signal, wherein the first input and the second input are temporally and spatially coherent; and
output a first output of the optical signal and a second output of the optical signal;
(ii) a first photodetector configured to receive the first output of the optical signal and generate a third output of the optical signal; and
(iii) a second photodetector configured to receive the second output of the optical signal and generate a fourth output of the optical signal;
(iv) the one or more unit cells being configured to output, as a unit cell output, the third output of the optical signal and the fourth output of the optical signal; and
(b) a controller configured to:
(i) encode a first vector in at least one of time-varying amplitudes of a first electric field or time-varying phases of the first electric field;
(ii) encode a second vector in at least one of time-varying amplitudes of a second electric field or time-varying phases of the second electric field; and
(iii) perform the at least one vector operation by multiplying the first vector and the second vector based on the unit cell output from the one or more of the plurality of unit cells, and determine a result of the multiplication.

2. The device of claim 1, further comprising:
(a) a plurality of the beam splitters;
(b) a light emitter configured to transmit the optical signal; and
(c) a plurality of modulators coupled with the photonic crossbar array, wherein one or more of the plurality of modulators is configured to:
(i) receive the optical signal from the light emitter;
(ii) modulate amplitudes of the optical signal;
(iii) modulate phases of the optical signal; and
(iv) transmit the modulated amplitudes of the optical signal and modulated phases of the optical signal to one or more of the plurality of beam splitters.

3. The device of claim 1, further comprising an intensity modulator configured to:
(a) receive optical signals from a light source;
(b) modulate the amplitudes of the optical signal; and
(c) transmit modulated amplitudes of the optical signal to a plurality of modulators.

4. The device of claim 3, wherein the intensity modulator is at least one of a balanced Mach-Zehnder Interferometer (MZI) or a ring resonator.

5. The device of claim 1, wherein the beam splitter is at least one of a 3 dB directional coupler, a 50:50 beam splitter, or a multimode interferometer.

6. The device of claim 1, further comprising a fixed-weight photonic component.

7. The device of claim 1, wherein the beam splitter, the first photodetector, and the second photodetector are disposed on a substrate.

8. The device of claim 1, wherein (i) the beam splitter is disposed on a substrate, and (ii) the first photodetector and the second photodetector are disposed in free space.

9. The device of claim 1, wherein the optical signal encodes at least one matrix element, the at least one matrix element being at least one of a tensor, a matrix, or a vector.

10. A method of performing at least one vector operation, comprising:
(a) encoding, by a controller, a first vector in at least one of time-varying amplitudes of a first electric field or time-varying phases of the first electric field;
(b) encoding, by the controller, a second vector in at least one time-varying amplitudes of a second electric field or time-varying phases of the second electric field;
(c) transmitting, by the controller, (i) a first input of an optical signal and (ii) a second input of the optical signal to a beam splitter to generate a first output of the optical signal and a second output of the optical signal, wherein the first input and the second input are temporally and spatially coherent;
(d) transmitting, by the controller, the first output of the optical signal to a first photodetector to generate a third output of the optical signal;
(e) transmitting, by the controller, the second output of the optical signal to a second photodetector to generate a fourth output of the optical signal, the third output of the optical signal and the fourth output of the optical signal defining a unit cell output; and
(f) performing the at least one vector operation by multiplying the first vector and the second vector based on the unit cell output from one or more of a plurality of unit cells; and
(g) determining, by the controller, a result of the multiplication of the first vector and the second vector.

11. The method of claim 10, further comprising determining, by the controller, a difference between the third output of the optical signal and the fourth output of the optical signal.

12. The method of claim 10, further comprising time-multiplexing, by the controller, the first vector and the second vector.

13. The method of claim 10, wherein the optical signal encodes matrix elements of at least one of a tensor, a matrix, or a vector.

14. The method of claim 13, further comprising scaling, by the controller, the matrix elements of at the least one of the matrix or the vector to a value in a range of [−1, 1].

15. The method of claim 10, further comprising performing, by the controller, real or complex matrix multiplication by controlling phases of the optical signal and amplitudes of the optical signal.

16. The method of claim 10, further comprising measuring, by the controller, optical intensity on a substrate.

17. The method of claim 10, further comprising transmitting, by a light source, the optical signal.

18. The method of claim 10, further comprising:
(a) receiving, by one or more of a plurality of modulators, the optical signal from a light source;
(b) modulating, by the one or more of the modulators, amplitudes of the optical signal;
(c) modulating, by the one or more of the modulators, phases of the optical signal; and
(d) transmitting, by the one or more of the modulators, the modulated amplitudes of the optical signal and modulated phases of the optical signal to the beam splitter.

19. The method of claim 10, further comprising transmitting, by the controller, the optical signal through a fixed-weight photonic component.

20. The method of claim 10, further comprising:
(a) disposing the beam splitter on a substrate; and
(b) disposing the first photodetector and the second photodetector in free space.
